(19) United States
(12) Patent Application Publication
(10) Pub. No.: US 2025/0199648 A1
(43) Pub. Date: Jun. 19, 2025

(54) Touch Panel and Display Device

(71) Applicant: LG Display Co., Ltd., Seoul (KR)

(72) Inventors: Shinji Takasugi, Kanagawa (JP); Tomonori Miyokawa, Kanagawa (JP)

(21) Appl. No.: 18/955,721

(22) Filed: Nov. 21, 2024

(30) Foreign Application Priority Data
Dec. 15, 2023 (JP) 2023-211640

(51) Int. Cl. G06F 3/044

(52) U.S. Cl. CPC G06F 3/0446; G06F 2203/04111

(57) ABSTRACT

A touch panel includes a plurality of touch electrodes arranged in a matrix shape in a first direction and a second direction intersecting the first direction, wherein the touch electrode has a length 1.5 times or longer than a distance between the touch electrode and another touch electrode adjacent to the touch electrode in the first direction or the second direction, and wherein the length is a length of the touch electrode in a direction intersecting the first direction and the second direction.

### CROSS-REFERENCE TO RELATED APPLICATION

The present application claims priority to Japanese Patent Application No. 2023-211640 filed in Japan on Dec. 15, 2023, which is hereby incorporated by reference in its entirety.

### BACKGROUND

### Field of the Disclosure

The present disclosure relates to a touch panel and a display device.

### Discussion of the Background Art

In general, tablet terminals, smartphones, etc. have a touch panel that detects a touch position by a user by detecting a change in capacitance. For example, Japanese Patent No. 7043586 (referred to herein as Patent Document 1) describes a capacitive touch sensor that detects a touch position with high precision. This touch sensor has a plurality of conductive sensor elements, and each sensor element has a plurality of main branches and a plurality of sub-branches. In order to improve the detection accuracy between two adjacent sensor elements, the sub-branches of two adjacent sensor elements among the plurality of sensor elements are arranged alternately.

Even in the touch sensor described in Patent Document 1, the detection precision of the touch position was not necessarily sufficient.

### SUMMARY

Accordingly, the present disclosure is to provide a touch panel and display device that substantially obviate one or more of the limitations and disadvantages described above and associated with the background art.

More specifically, an object of the present disclosure is to provide a touch panel and display device capable of improving the detection precision of the touch position.

Additional features and embodiments will be set forth in the description that follows, and in part will be apparent from the description, or can be learned by practice of the present disclosure provided herein. Other features and embodiments of the inventive concepts can be realized and attained by the structure particularly pointed out in the written description, or derivable therefrom, and the claims hereof as well as the appended drawings.

To achieve these and other embodiments of the present disclosure, as embodied and broadly described herein, a touch panel includes a plurality of touch electrodes arranged in a matrix shape in a first direction and a second direction intersecting the first direction, wherein the touch electrode has a length 1.5 times or longer than a distance between the touch electrode and another touch electrode adjacent to the touch electrode in the first direction or the second direction, and wherein the length is a length of the touch electrode in a direction intersecting the first direction and the second direction.

In another embodiment, a touch panel includes a plurality of first touch electrodes each extending in a first direction; and a plurality of second touch electrodes each extending in a second direction intersecting the first direction, wherein a width of the first touch electrode in the second direction is longer than a distance between another adjacent first touch electrodes, and wherein a width of the second touch electrode in the first direction is longer than a distance between another adjacent second touch electrodes.

In another embodiment, a display device includes a touch panel; and a display panel provided on a rear surface side of the touch panel.

It is to be understood that both the foregoing general description and the following detailed description are examples and are intended to provide further explanation of the inventive concepts as claimed.

### BRIEF DESCRIPTION OF THE DRAWINGS

The accompanying drawings, which are included to provide a further understanding of the present disclosure and which are incorporated in and constitute a part of this application, illustrate embodiments of the disclosure and together with the description serve to explain various principles of the present disclosure.

In the drawings:

FIG. 1 is a block diagram showing a configuration example of a display device according to a first embodiment;

FIG. 2 is a view showing a schematic configuration example of a touch panel according to the first embodiment;

FIG. 3 is a front view showing a configuration example of a touch electrode according to the first embodiment;

FIG. 4 is a front view showing a configuration example of a touch panel according to the first embodiment;

FIG. 5 is a view showing the electric field intensity of a touch electrode according to the first embodiment;

FIG. 6 is a view showing the number of touch electrodes occupying a predetermined area according to the first embodiment;

FIG. 7 is a view showing the electric field intensity of a touch electrode according to a comparative example;

FIG. 8 is a view showing the number of touch electrodes occupying a predetermined area according to the comparative example;

FIG. 9 is a view showing the electric field intensity of a touch electrode according to a comparative example;

FIG. 10 is a view showing the number of touch electrodes occupying a predetermined area according to the comparative example;

FIG. 11 is a front view showing a configuration example of a touch electrode according to a second embodiment;

FIG. 12 is a front view showing a configuration example of a touch panel according to the second embodiment;

FIG. 13 is an enlarged view of the intersection portion Q of FIG. 12 according to one embodiment;

FIG. 14 is a cross-sectional view of the line V-V of FIG. 13 according to one embodiment;

FIG. 15 is a view showing the electric field intensity of a touch electrode according to the second embodiment;

FIG. 16 is a view showing the number of touch electrodes occupying a predetermined area according to the second embodiment;

FIG. 17 a view showing a schematic configuration example of a touch panel according to a third embodiment;

FIG. 18 is a front view showing a configuration example of a first touch electrode according to the third embodiment;

FIG. 19 is a front view showing a configuration example of a second touch electrode according to the third embodiment;

FIG. 20 is a front view showing a configuration example of a touch panel according to the third embodiment;

FIG. 21 is an enlarged view of the intersection portion Q of FIG. 20 according to one embodiment;

FIG. 22 is a cross-sectional view of the line V-V of FIG. 21 according to one embodiment;

FIG. 23 is a view showing the electric field intensity in inter-electrode of the first touch electrode and the second touch electrode according to the third embodiment;

FIG. 24 is a view showing the number of inter-electrodes of each touch electrode occupying a predetermined area according to the third embodiment;

FIG. 25 is a view showing the electric field intensity in inter-electrode of a first touch electrode and a second touch electrode according to a comparative example;

FIG. 26 is a view showing the number of inter-electrodes of each touch electrode occupying a predetermined area according to the comparative example;

FIG. 27 is a view showing the electric field intensity in inter-electrode of a first touch electrode and a second touch electrode according to a comparative example;

FIG. 28 is a view showing the number of inter-electrodes of each touch electrode occupying a predetermined area according to the comparative example;

FIG. 29 is a front view showing a configuration example of a first touch electrode according to a fourth embodiment;

FIG. 30 is a front view showing a configuration example of a second touch electrode according to the fourth embodiment;

FIG. 31 is a front view showing a configuration example of a touch panel according to the fourth embodiment;

FIG. 32 is an enlarged view of the intersection portion Q of FIG. 31 according to one embodiment;

FIG. 33 is a cross-sectional view of the line V-V of FIG. 32 according to one embodiment;

FIG. 34 is a view showing the electric field intensity in inter-electrode of the first touch electrode and the second touch electrode according to the fourth embodiment; and

FIG. 35 is a view showing the number of inter-electrodes of each touch electrode occupying a predetermined area according to the fourth embodiment.

### DETAILED DESCRIPTION

Hereinafter, embodiments according to the present disclosure will be described in detail with reference to the drawings. Throughout each drawing, elements having common functions are given the same references, and in some cases, duplicate descriptions are omitted or simplified.

### First Embodiment

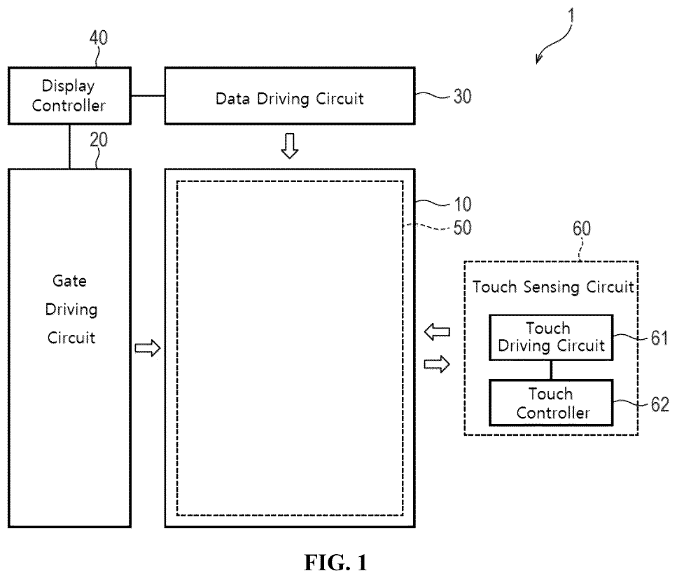

A display device 1 according to a first embodiment can be a so-called touch display, and can be applied to, for example, tablet terminals, smartphones, notebook computers, bank ATMs, ticket machines, unmanned reception machines, etc. As shown in FIG. 1, the display device 1 can include a display panel 10, a gate driving circuit 20, a data driving circuit 30, a display controller 40, a touch panel 50, and a touch sensing circuit 60.

The display panel 10 can display information. For example, the display panel 10 can be an OLED (organic light-emitting diode) panel, but may be composed of other display panels such as a liquid crystal display (LCD). The display panel 10 can have a rectangular display screen that displays information and can be installed on the back side of the touch panel 50. The display panel 10 can include a plurality of sub-pixels (not shown) of respective colors such as RGB. The plurality of sub-pixels can be driven by a gate driving circuit 20 and a data driving circuit 30.

The gate driving circuit 20 can be connected to a sub-pixel through a gate line and can select the sub-pixel by switching a gate transistor of the sub-pixel through the gate line.

The data driving circuit 30 can be connected to a sub-pixel through a data line and can allow the sub-pixel to emit light by applying a voltage to the sub-pixel through the data line.

The display controller 40 can control the gate driving circuit 20 and the data driving circuit 30. The display controller 40 can control, for example, the gate driving circuit 20 to select a sub-pixel, and then control the data driving circuit 30 to allow the sub-pixel selected by the gate driving circuit 20 to emit light. As a result, the display panel 10 can display information from the back side of the touch panel 50 toward the front side of the touch panel 50.

The touch panel 50 can detect a touch by a user. The touch panel 50 can be a self-capacitive touch panel that detects an increase in capacitance of a touch electrode 52 described below when touched by a conductor such as a touch pen or a human finger. The touch panel 50 can be formed in a rectangular shape with a size equal to the display screen of the display panel 10 and can be installed on the display screen of the display panel 10. The touch panel 50 may be manufactured separately from the display panel 10 and then attached to the display panel 10, or may be laminated within the display panel 10.

Here, the horizontal direction of the touch panel 50 can be referred to as the X direction (first direction), the vertical direction of the touch panel 50 can be referred to as the Y direction (second direction), and the direction orthogonal to the operating surface of the touch panel 50 can be referred to as the Z direction.

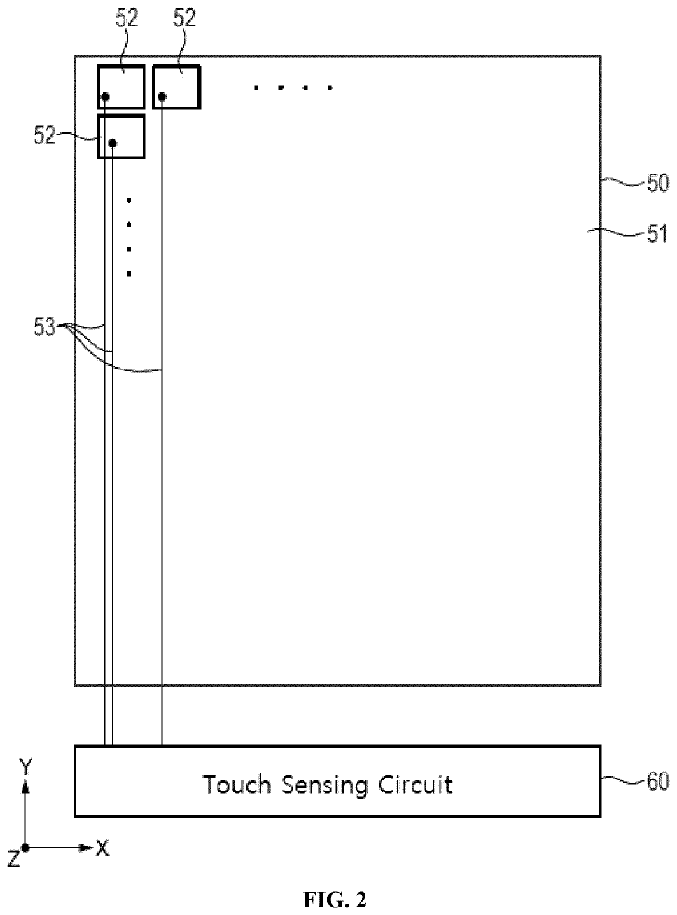

As shown in FIG. 2, the touch panel 50 can include a base member 51, a plurality of touch electrodes 52, and a plurality of signal lines 53.

The base member 51 can be a member in the shape of a film (plate) formed of a dielectric such as glass or transparent resin, for example. The plurality of touch electrodes 52 can be formed on the base member 51.

The plurality of touch electrodes 52 can detect touches by the conductor such as a touch pen or a human finger. The plurality of touch electrodes 52 can be formed on the base member 51 by patterning a transparent conductive thin film such as ITO (indium tin oxide) or IZO (indium zinc oxide). The method of forming a pattern of the touch electrode 52 on the base member 51 may be considered to use, for example, photolithography technology, screen printing technology, inkjet printing technology, etc. In addition, FIG. 2 shows a schematic configuration of the touch electrode 52 in order to facilitate understanding of the invention.

The plurality of signal lines 53 can electrically connect the plurality of touch electrodes 52 and the touch sensing circuit 60. As shown in FIG. 2, the plurality of signal lines 53 can individually connect each of the touch electrodes 52 and the touch sensing circuit 60.

The touch sensing circuit 60 can determine a touch position by a user and can include a touch driving circuit F and a touch controller 62.

The touch driving circuit 61 can be an example of a detection circuit and can detect a change in capacitance (self-capacitance) of each of the plurality of touch electrodes 52. The touch driving circuit 61 can detect, for example, a voltage change or a frequency change of the plurality of touch electrodes 52 through the signal lines 53. The touch driving circuit 61 can output the detected voltage change or frequency change to the touch controller 62.

The touch controller 62 can determine the touch position by the user. The touch controller 62 can determine the presence or absence and the position of a touch by the user based on, for example, an output value output from the touch driving circuit 61. The touch controller 62 can compare, for example, the output value output from the touch driving circuit 61 with a predetermined threshold, and can determine that a touch has been made if the output value is higher than the threshold. On the other hand, the touch controller 62 can determine that a touch has not been made if the output value is lower than the threshold. The touch controller 62 can output the position of the XY coordinates of the touched touch electrode 52 on the touch panel 50 as touch position data. In addition, the touch controller 62 can determine a touch position between adjacent touch electrodes 52 by calculating the output values of adjacent touch electrodes 52. Here, as long as at least three adjacent touch electrodes 52 are included within the touch area, the touch controller 62 can determine the touch position between the adjacent touch electrodes 52 in each of the X direction and the Y direction.

The display device 1 configured as described above can have a feature of the plurality of touch electrodes 52 constituting the touch panel 50. Hereinafter, the plurality of touch electrodes 52 will be described in detail.

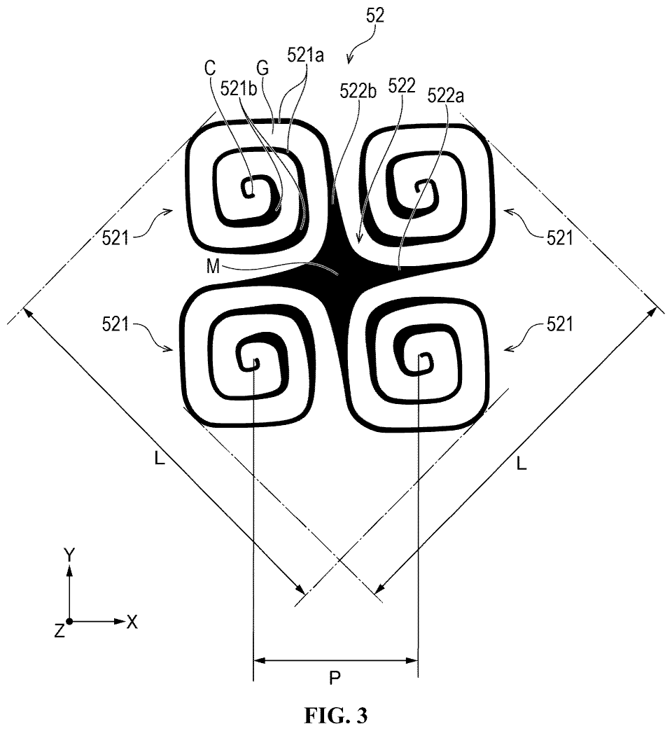

As shown in FIG. 3, for example, the touch electrode 52 can be configured to include a plurality of spiral patterns 521 and a connecting pattern 522. In this example, one touch electrode 52 can be configured to include four spiral patterns 521.

The four spiral patterns 521 can each be formed in the same spiral shape in a plan view. Here, in a plan view means that they are viewed from the Z direction orthogonal to the operating surface of the touch panel 50.

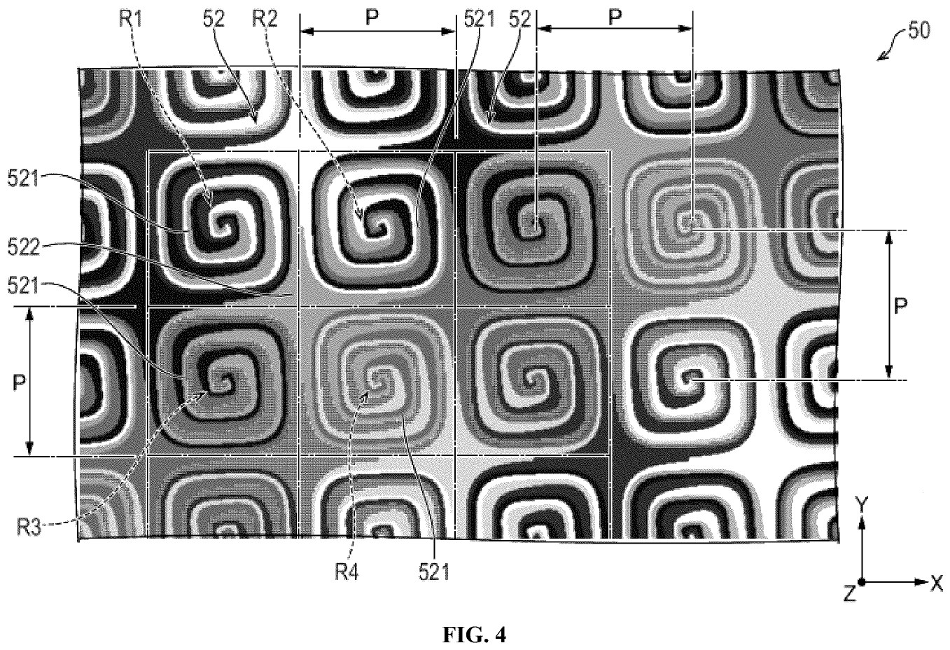

The four spiral patterns 521 can be arranged respectively in four regions R1, R2, R3, and R4 that are obtained by equally dividing the touch electrode 52 along the X direction and the Y direction, as shown in FIG. 4. That is, the four spiral patterns 521 can be arranged in four regions R1, R2, R3, and R4 that are provided in a matrix shape along the X direction and the Y direction. In other words, two spiral patterns 521 can be arranged side by side in each of the X direction and the Y direction.

The spiral pattern 521 can be wound in a spiral shape with the center C as the starting point. A gap G can be formed between two adjacent circumferential portions 521a of the spiral pattern 521. The gap G can also have a spiral shape in a plan view. As described below, a spiral pattern 521 of another touch electrode 52 adjacent thereto can be disposed in the gap G.

As shown in FIG. 3, the line width of the spiral pattern 521 can be narrower as the distance from the center portion M of the touch electrode 52 increases. That is, the line width of the spiral pattern 521 can be wider as it approaches the center portion M of the touch electrode 52. In other words, the spiral pattern 521 can have a wide portion 521b formed with a wide width of its circumferential portion 521a, and this wide portion 521b can be located at the center portion M side of the touch electrode 52. Here, the center portion M of the touch electrode 52 can refer to the center of the touch electrode 52 in the X direction, and also refer to the center of the touch electrode 52 in the Y direction.

The connecting pattern 522 can connect the four spiral patterns 521. The connecting pattern 522 can be disposed in the center portion M of the touch electrode 52 and can have a first extension part 522a and a second extension part 522b.

The first extension part 522a can extend along the X direction and can be formed in a linear shape. The first extension part 522a can have one end connected to the spiral pattern 521 of the region R2 in the X direction and the other end connected to the spiral pattern 521 of the region R3 in the X direction.

The second extension part 522b can be formed integrally with the first extension part 522a as one body, can extend along the Y direction, and can be formed in a linear shape. The second extension part 522b can intersect the first extension part 522a at the center portion M and form a +(plus) shape with the first extension part 522a. The second extension part 522b can have one end connected to the spiral pattern 521 of the region R1 in the Y direction and the other end connected to the spiral pattern 521 of the region R4 in the Y direction.

The line width of the connecting pattern 522 can be formed to be narrower as the distance from the center portion M of the touch electrode 52 increases. For example, the first extension part 522a can be formed to be narrower as the distance from the center portion M increases along the X direction. That is, the first extension part 522a can be formed to be narrower at the fore-end than at the center portion M in the X direction. The second extension part 522b can be formed to be narrower as the distance from the center portion M increases along the Y direction. That is, the second extension part 522b can be formed to be narrower at the fore-end than at the center portion M in the Y direction. The connecting pattern 522 can electrically connect the four spiral patterns 521 included in the regions R1, R2, R3, and R4 by the first extension part 522a and the second extension part 522b.

In the touch electrode 52 configured as described above, a ratio of the conductive thin film per unit area of the center portion M of the touch electrode 52 can be greater than a ratio of the conductive thin film per unit area of the peripheral portion located around the center portion M. That is, the closer the touch electrode 52 is to the center portion M, the higher the area ratio of the conductive thin film, and the farther away from the center portion M, the lower the area ratio of the conductive thin film. According to this, the touch electrode 52 can make the sensitivity of the center portion M higher than that of the peripheral portion of the touch electrode 52, and as a result, the touch position can be accurately detected.

As shown in FIG. 3, the spiral pattern 521 can have the circumferential portion 521a extending spirally from the center C, and the gap G can be provided between the inner circumferential portion 521a and the outer circumferential portion 521a. In the four regions R1, R2, R3, and R4, a part of the spiral pattern 521 of another touch electrode 52 adjacent thereto can be disposed in the gap G of the spiral pattern 521. That is, the circumferential portion 521a of another touch electrode 52 can be disposed in the gap G between two adjacent circumferential portions 521a included in the spiral pattern 521. And, in the four regions R1, R2, R3, and R4, the circumferential portions 521a of four spiral patterns 521 of four touch electrodes 52 adjacent to each other in the X direction, the Y direction, and the diagonal direction (the diagonal direction of the rectangular touch electrode 52) can be electrically independent from each other. As such, the four regions R1, R2, R3, and R4 can include the circumferential portions 521a of the spiral patterns 521 of the four different touch electrodes 52 in an electrically independent state from each other, respectively.

As shown in FIG. 4, for example, the plurality of touch electrodes 52 can be arranged in a matrix shape with an interval of distance P along the X direction and the Y direction. That is, the plurality of touch electrodes 52 can be arranged with the interval of distance P along the X direction and can also be arranged with the interval of distance P along the Y direction, which is the same as the X direction. The distance P can be an interval for arranging the plurality of touch electrodes 52 along the X direction, and can also be an interval for arranging the plurality of touch electrodes 52 along the Y direction. The plurality of touch electrodes 52 can each be electrically independent. That is, each touch electrode 52 may not be electrically connected to another touch electrode 52.

As shown in FIG. 3, when a length of the touch electrode 52 in the direction intersecting the X direction and the Y direction is defined as a length L, the touch electrode 52 can have the length L that is 1.5 times or longer than the distance P between the touch electrode 52 and another touch electrode 52 adjacent thereto in the X direction or the Y direction. That is, in a plan view, the maximum length L of the touch electrode 52 in the direction intersecting the X direction and the Y direction can be 1.5 times or longer than the distance P between the touch electrode 52 and another touch electrode 52 adjacent thereto. In other words, the touch electrode 52 can be formed in a rectangular shape, and the length L of the touch electrode 52 in the diagonal direction can be 1.5 times or longer than the distance P between the touch electrode 52 and another touch electrode 52 adjacent thereto. As such, the touch electrode 52 can be formed to have a longer diagonal length than the distance P between the adjacent touch electrodes 52. Thereby, the touch electrode 52 can include another adjacent touch electrodes 52 in the common region not only in the X direction and the Y direction but also in the diagonal direction thereof. Thereby, the touch electrode 52 can increase the number of touch electrodes 52 included in the touch area, and as a result, the touch position can be accurately detected. In addition, the distance P between the adjacent touch electrodes 52 in the X direction and the distance P between the adjacent touch electrodes 52 in the Y direction can be typically the same distances, but are not limited thereto. The distances P in the X direction and the Y direction may be different, respectively. In addition, the diagonal direction can be the direction intersecting the X direction and the Y direction, and can be typically an intersecting direction inclined at 45 degrees with respect to the X direction and the Y direction.

In these touch electrodes 52, each of the four regions R1, R2, R3, and R4 arranged in a matrix shape along the X direction and the Y direction can include four spiral patterns 521 in four touch electrodes 52 adjacent to each other. That is, the region R1 can include the spiral patterns 521 of the four touch electrodes 52 adjacent to each other in the X direction, the Y direction, and the diagonal direction. That is, the region R1 can include a total of four spiral patterns 521 in different touch electrodes 52. In addition, the region R1 can include the spiral patterns 521 of four different touch electrodes 52 that are in an electrically independent state from each other. Similarly, each of the regions R2, R3, and R4 can include the spiral patterns 521 of four different touch electrodes 52 that are in an electrically independent from each other.

Furthermore, the plurality of spiral patterns 521 in the plurality of adjacent touch electrodes 52 can share the center C. That is, in the four regions R1, R2, R3, and R4, the four spiral patterns 521 in the four adjacent touch electrodes 52 can be formed in a spiral shape around the common center C, and can each be electrically independent. For example, in the region R1, the four spiral patterns 521 in the four adjacent touch electrodes 52 in the X direction, the Y direction, and the diagonal direction can be formed in a spiral shape around the common center C included in the region R1, and can each be electrically independent. Likewise for the regions R2, R3, and R4, four spiral patterns 521 in four adjacent touch electrodes 52 in the X direction, Y direction, and diagonal direction can be formed in a spiral shape around the common center C included in the regions R2, R3, and R4, and can each be electrically independent.

The touch panel 50 can be configured with the plurality of touch electrodes 52 as described above, so that in the touch panel 50, an area including at least three different touch electrodes 52 inside a circle with a diameter of 5 mm can occupy ½ or more of the entire touch panel 50. In this case, the distance P indicating the interval between the touch electrodes 52 can be, for example, 7 mm, and the diagonal length L of the touch electrode 52 can be, for example, 18 mm.

Next, a comparison of the electric field intensity of the touch electrodes 52 according to the first embodiment and the electric field intensity of the touch electrodes 91 and 92 according to comparative examples will be described.

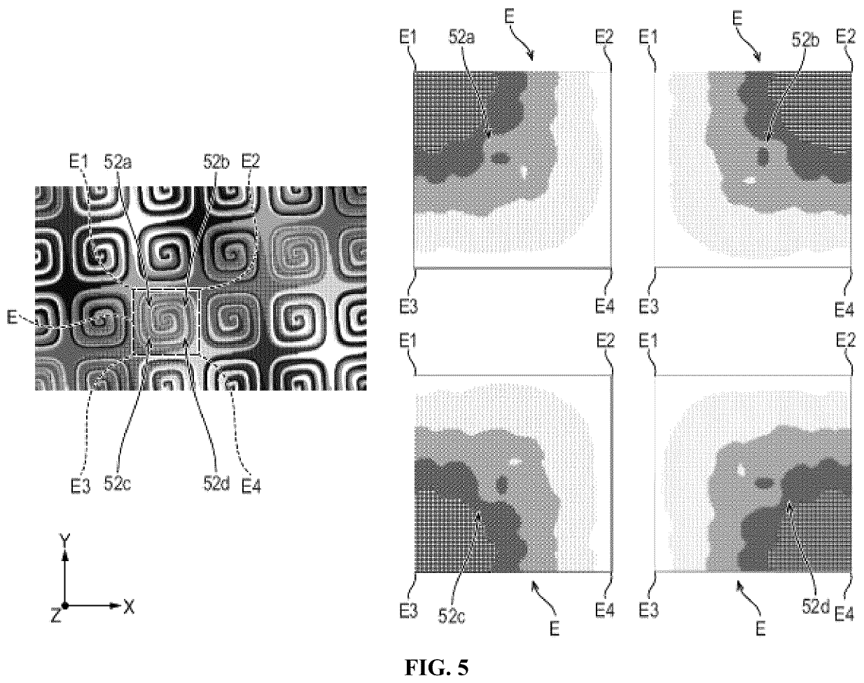

FIG. 5 is a view showing the electric field intensity of the touch electrodes 52 according to the first embodiment. The four drawings on the right side of FIG. 5 are drawings of enlarging the area E (area E composed of vertices E1, E2, E3, and E4) with respect to the touch electrodes 52a, 52b, 52c, and 52d of the drawing on the left side toward the paper surface. The area E can include four spiral patterns 521 in the four touch electrodes 52a, 52b, 52c, and 52d. The touch electrode 52a located at the upper left of the area E can have an electric field distributed from the upper left to the lower right of the area E. The touch electrode 52b located at the upper right of the area E can have an electric field distributed from the upper right to the lower left of the area E. The touch electrode 52c located at the lower left of the area E can have an electric field distributed from the lower left to the upper right of the area E. The touch electrode 52d located at the lower right of the area E can have an electric field distributed from the lower right to the upper left of the area E.

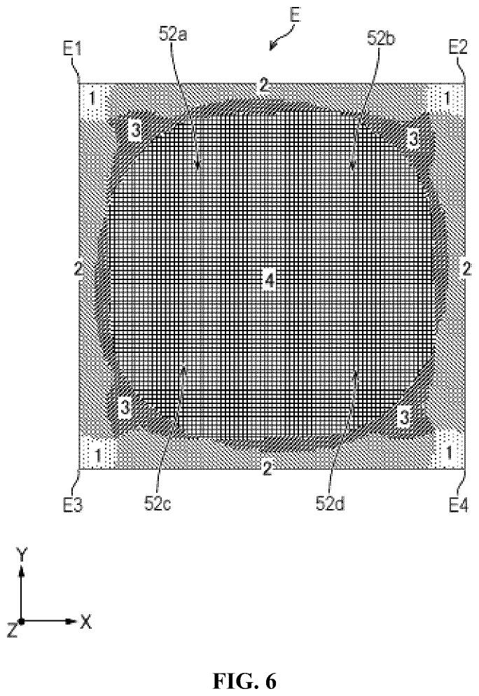

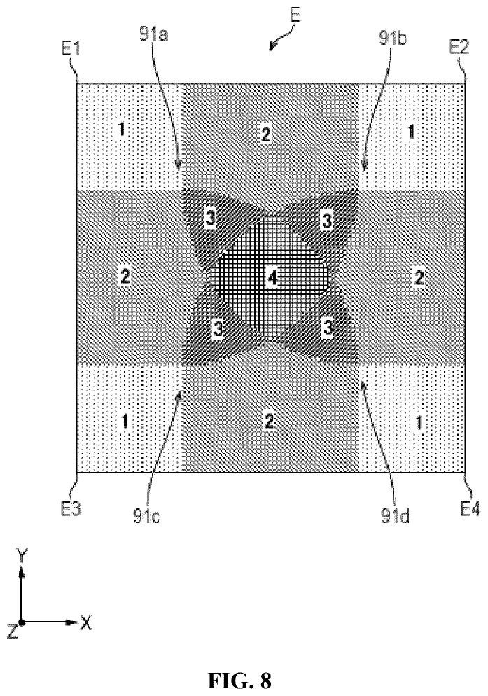

FIG. 6 is a view showing the number of touch electrodes 52 occupying a predetermined area according to the first embodiment. FIG. 6 shows the number of detectable touch electrodes 52 in the area E as “1” to “4”. In FIG. 6, when the number of touch electrodes 52 is 1, it can be shown as “1”, when the number of touch electrodes 52 is 2, it can be shown as “2”, and similarly, when the number of touch electrodes 52 is 3 and 4, it can be shown as “3” and “4”, respectively. The same can be shown for FIGS. 8, 10, 16, 24, 26, 28, and 35 below. As shown in FIG. 6, the number of detectable touch electrodes 52 can be 3 to 4 over a wide range of the area E. As such, since the touch panel 50 according to the first embodiment includes three or more touch electrodes 52 over a wide range of the area E, the touch position can be detected in two dimensions, so that the touch position can be detected accurately. In addition, for example, when the number of touch electrodes included in the area E is two or less, the touch position can be detected only in one dimension, and in this case, there is a concern that the detection accuracy of the touch position may be reduced.

The touch panel 50 according to the first embodiment can include a large number of touch electrodes 52 included in the area E, so that the error between the actual touch position and the touch position data can be reduced. As a result of actually measuring the error, the average error in the XY coordinates between the actual touch position and the touch position data of the touch panel 50 according to the first embodiment is 0.016 mm, so that it can be seen that the error is small. As such, the touch panel 50 according to the first embodiment can increase the number of touch electrodes 52 included in the touch area, so that the touch position can be accurately detected.

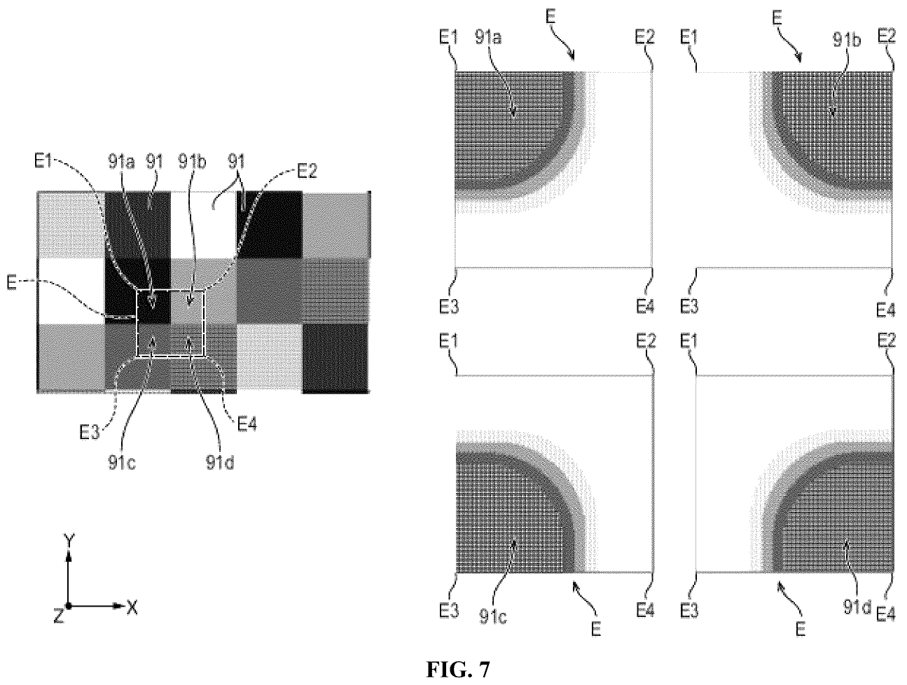

FIG. 7 is a view showing the electric field intensity of the touch electrodes 91 according to a comparative example. The touch electrodes 91 shown in FIG. 7 are formed in a square shape and are arranged in a matrix shape along the X direction and the Y direction. The four drawings on the right side toward the paper surface of FIG. 7 are drawings of enlarging the area E with respect to the touch electrodes 91a, 91b, 91c, and 91d of the drawing on the left side toward the paper surface. The area E includes a part of each of the four touch electrodes 91a, 91b, 91c, and 91d. The touch electrode 91a located at the upper left of the area E has an electric field distributed from the upper left to the lower right of the area E. The touch electrode 91b located at the upper right of the area E has an electric field distributed from the upper right to the lower left of the area E. The touch electrode 91c located at the lower left of the area E has an electric field distributed from the lower left to the upper right of the area E. The touch electrode 91d located at the lower right of the area E has an electric field distributed from the lower right to the upper left of the area E.

FIG. 8 is a view showing the number of touch electrodes 91 occupying a predetermined area according to the comparative example. As shown in FIG. 8, the number of detectable touch electrodes 91 in the center portion of the area E is 3 to 4, but the number of touch electrodes 91 in the relatively wide peripheral portion of the area E is 1 to 2. As such, when comparing the touch electrodes 91 with the touch electrodes 52 according to the first embodiment shown in FIG. 6, the area where the number of touch electrodes 91 is 3 to 4 is smaller than that in the first embodiment.

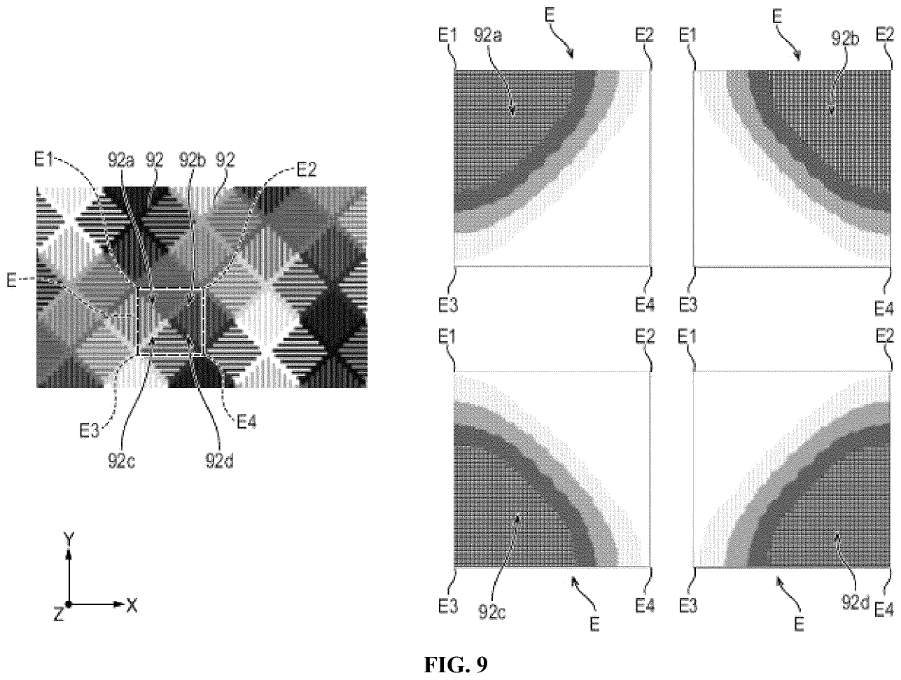

FIG. 9 is a view showing the electric field intensity of the touch electrodes 92 according to a comparative example. The touch electrodes 92 shown in FIG. 9 are formed in a rhombus shape and are arranged in a matrix shape along the X direction and the Y direction. Adjacent touch electrodes 92 in the X direction are included in a common region, and adjacent touch electrodes 92 in the Y direction are included in a common region. The four drawings on the right side toward the paper surface of FIG. 9 are drawings of enlarging the area E with respect to the touch electrodes 92a, 92b, 92c, and 92d of the drawing on the left side toward the paper surface. The area E includes a part of each of the four touch electrodes 92a, 92b, 92c, and 92d. The touch electrode 92a located at the upper left of the area E has an electric field distributed from the upper left to the lower right of the area E. The touch electrode 92b located at the upper right of the area E has an electric field distributed from the upper right to the lower left of the area E. The touch electrode 92c located at the lower left of the area E has an electric field distributed from the lower left to the upper right of the area E. The touch electrode 92d located at the lower right of the area E has an electric field distributed from the lower right to the upper left of the area E.

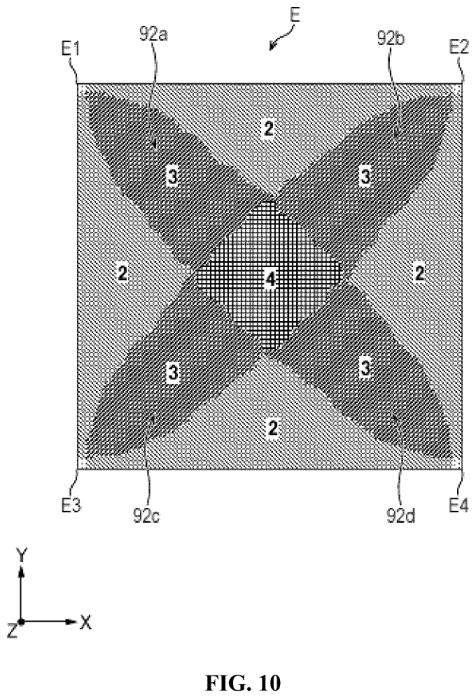

FIG. 10 is a view showing the number of touch electrodes 92 occupying a predetermined area according to the comparative example. As shown in FIG. 10, the number of detectable touch electrodes 92 in the center portion of the area E is 3 to 4, but the number of touch electrodes 92 in the peripheral portion of the area E is 1 to 2. As such, when comparing the touch electrodes 92 with the touch electrodes 52 according to the first embodiment shown in FIG. 6, the area where the number of touch electrodes 92 is 3 to 4 is smaller than that in the first embodiment. In this way, since the touch panel according to the comparative example has a smaller number of touch electrodes 92 included in the area E, there is a tendency for the error between the actual touch position and the touch position data to increase. As a result of actually measuring the error, the average error in the XY coordinates between the actual touch position and the touch position data of the touch panel according to the comparative example is 0.098 mm to 0.422 mm, which is greater than the average error (0.016 mm) of the touch electrode 52 according to the first embodiment.

As described above, the touch panel 50 according to the first embodiment can include the plurality of touch electrodes 52 arranged in a matrix shape in the X direction and the Y direction intersecting the X direction. The touch electrode 52 can have the length L that is 1.5 times or longer than the distance P between the touch electrode 52 and another touch electrode 52 adjacent thereto in the X direction or the Y direction. The length L can be a length of the touch electrode 52 in the direction intersecting the X direction and the Y direction.

By this configuration, the touch panel 50 can extend the touch electrode 52 along the direction (diagonal direction) intersecting the X direction and the Y direction. By this, the touch panel 50 can include adjacent touch electrodes 52 in the common region not only in the X direction and the Y direction but also in the diagonal direction. By this, the touch panel 50 can increase the number of touch electrodes 52 included in the touch area without increasing the total number of touch electrodes 52 included in the touch panel 50, and as a result, the touch position can be accurately detected.

In the touch panel 50, the touch electrode 52 can include a pattern having the gap G in a plan view, and a part of the pattern of another touch electrode 52 adjacent thereto can be disposed in the gap G. By this configuration, the touch panel 50 can include the patterns of the plurality of touch electrodes 52 in the common region while being electrically independent from the spiral patterns 521 of another adjacent touch electrodes 52.

In the above touch panel 50, each of the four regions R1, R2, R3, and R4 obtained by equally dividing the touch electrode 52 along the X and Y directions can include the four patterns of the four touch electrodes 52 adjacent to each other. By this configuration, the touch panel 50 can increase the number of touch electrodes 52 included in the touch area, and as a result, the touch position can be accurately detected.

In the above touch panel 50, the pattern can be the spiral pattern 521 that extends in a spiral shape from the predetermined center C in a plan view. By this configuration, the touch panel 50 can include the patterns of the plurality of touch electrodes 52 in the common region.

In the above touch panel 50, the spiral patterns 521 of the plurality of adjacent touch electrodes 52 can share the center C. By this configuration, the touch panel 50 can efficiently include the patterns of the plurality of touch electrodes 52 in the common region.

In the above touch panel 50, the circumferential portion 521a of another touch electrode 52 can be placed in the gap G between two adjacent circumferential portions 521a included in the spiral pattern 521. By this configuration, the touch panel 50 can include the spiral patterns 521 of the plurality of touch electrodes 52 in the common region while being electrically independent from the spiral patterns 521 of another adjacent touch electrodes 52.

In the above touch panel 50, the touch electrode 52 can include the four spiral patterns 521 arranged in a matrix shape in the X direction and the Y direction and the connecting pattern 522 arranged in the center portion M of the touch electrode 52 and connecting the four spiral patterns 521. By this configuration, the touch panel 50 can electrically connect the four spiral patterns 521 by the connecting pattern 522.

In the above touch panel 50, the line width of each of the spiral patterns 521 and the connecting pattern 522 can be formed to be narrower as the distance from the center portion M increases. By this configuration, the touch panel 50 can increase the area ratio of the touch electrode 52 as it gets closer to the center portion M of the touch electrode 52. By this, the touch panel 50 can make the sensitivity of the center portion M higher than that of the peripheral portion of the touch electrode 52, and as a result, the touch position can be accurately detected.

In the above touch panel 50, the area including at least three touch electrodes 52 inside a circle with a diameter of 5 mm can occupy ½ or more of the entire touch panel 50. By this configuration, the touch panel 50 can increase the touch area including many touch electrodes 52, and as a result, the touch position can be accurately detected.

### Second Embodiment

Next, a touch panel 50A according to a second embodiment will be described. The touch panel 50A according to the second embodiment can be different from the touch panel 50 according to the first embodiment in that the pattern of the touch electrode 54 can be a mosaic pattern 541.

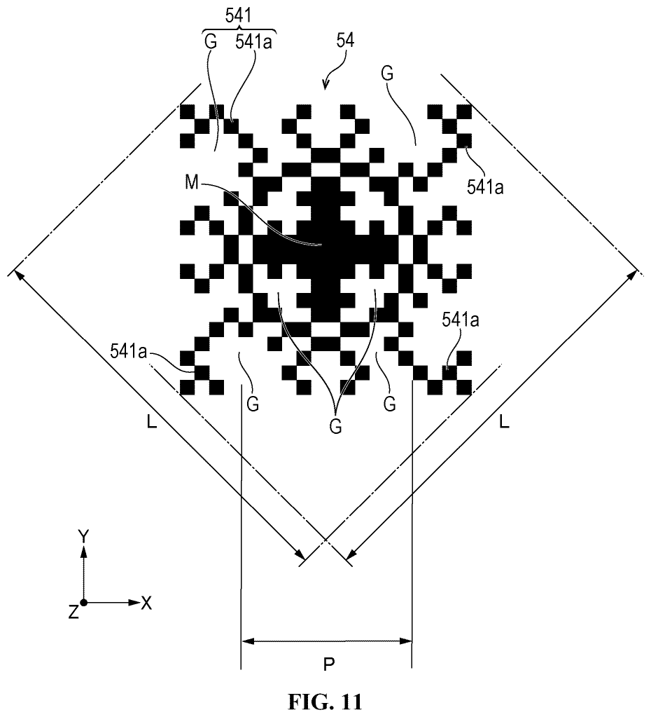

The touch panel 50A can be a self-capacitive touch panel that detects an increase in capacitance when touched by a conductor such as a touch pen or a human finger. The touch panel 50A can be configured to include a plurality of touch electrodes 54. The touch electrode 54 can be configured to include a mosaic pattern 541, as shown in FIG. 11, for example.

The mosaic pattern 541 can be a pattern that includes a plurality of electrode pieces 541a of a predetermined shape. For example, the electrode pieces 541a of the mosaic pattern 541 can be formed in a rectangular shape, and the electrode pieces 541a can be arranged so as to have a predetermined shape. The mosaic pattern 541 can be formed to include the plurality of electrode pieces 541a and a plurality of gaps G, for example, in a predetermined rectangular shape area. In addition, the electrode pieces 541a of the mosaic pattern 541 can be electrically connected to each other.

The number of electrode pieces 541a per unit area of the mosaic pattern 541 can decrease as the distance from the center portion M of the mosaic pattern 541 increases. That is, the number of electrode pieces 541a per unit area of the mosaic pattern 541 can increase as the distance from the center portion M of the mosaic pattern 541 decreases. In other words, the closer the mosaic pattern 541 is to the center portion M, the higher the area ratio of the conductive thin film, and the farther from the center portion M, the lower the area ratio of the conductive thin film. Therefore, the touch electrode 54 having the mosaic pattern 541 can make the sensitivity of the center portion M higher than that of the peripheral portion of the touch electrode 54, and as a result, the touch position can be accurately detected. Here, the center portion M can refer to the center of the mosaic pattern 541 in the X direction, and can also refer to the center of the mosaic pattern 541 in the Y direction.

In the four regions R1, R2, R3, and R4, the electrode pieces 541a of the mosaic patterns 541 of another adjacent touch electrodes 54 can be disposed in the gaps G of the mosaic pattern 541. And, in the four regions R1, R2, R3, and R4, four mosaic patterns 541 of four adjacent touch electrodes 54 in the X direction, the Y direction, and the diagonal direction (the diagonal direction of the rectangular touch electrode 54) can each be electrically independent from each other. That is, the mosaic patterns 541 of the four touch electrodes 54 adjacent to each other in the X direction, the Y direction, and the diagonal direction may not be electrically connected to each other. As such, in the four regions R1, R2, R3, and R4, the mosaic patterns 541 of the four different touch electrodes 54 can each be included in an electrically independent state.

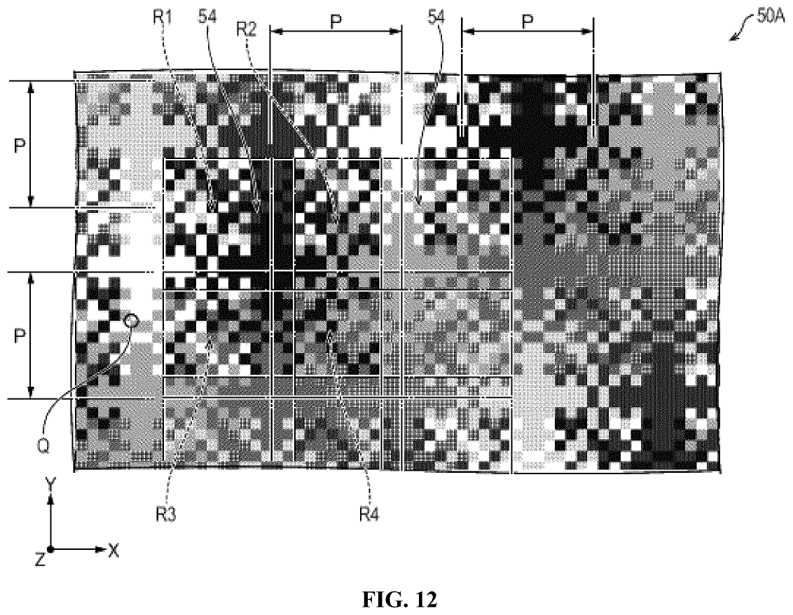

The plurality of touch electrodes 54 can be arranged in a matrix shape with an interval of distance P along the X direction and the Y direction, as shown in FIG. 12, for example. That is, the plurality of touch electrodes 54 can be arranged with the interval of distance P along the X direction, and can also be arranged with the interval of distance P along the Y direction, which is the same as the X direction. The plurality of touch electrodes 54 can each be electrically independent. That is, each touch electrode 54 may not be electrically connected to other touch electrodes 54.

As shown in FIG. 11, when a length of the touch electrode 54 in the direction intersecting the X direction and the Y direction is defined as the length L, the touch electrode 54 can have the length L that is 1.5 times or longer than the distance P between the touch electrode 54 and another touch electrode 54 adjacent thereto in the X direction or the Y direction. That is, in a plan view, the maximum length L of the touch electrode 54 in the direction intersecting the X and Y directions can be 1.5 times or longer than the distance P between the touch electrode 54 and another touch electrode 54 adjacent thereto. In other words, the touch electrode 54 can be formed so that the electrode pieces 541a and the gaps G can be included within a rectangular area, and the diagonal length L of the touch electrode 54 can be 1.5 times or longer than the distance P between the touch electrode 54 and another touch electrode 54 adjacent thereto. As such, the touch electrode 54 can be formed to have a longer diagonal length than the distance P between the adjacent touch electrodes 54. Thereby, the touch electrode 54 can include adjacent touch electrodes 54 in the common region not only in the X and Y directions but also in the diagonal direction. By this, the touch electrode 54 can increase the number of touch electrodes 54 included in the touch area, and as a result, the touch position can be accurately detected. In addition, the distance P between the adjacent touch electrodes 54 in the X direction and the distance P between the adjacent touch electrodes 54 in the Y direction can be typically the same distance, but are not limited thereto. The distances P in the X direction and the Y direction may be different.

In these touch electrodes 54, each of the four regions R1, R2, R3, and R4 arranged in a matrix shape along the X-direction and the Y-direction can include the mosaic patterns 541 of four touch electrodes 54 adjacent to each other. That is, the region R1 can include the mosaic patterns 541 of four touch electrodes 54 adjacent to each other in the X-direction, the Y-direction, and the diagonal direction. That is, the region R1 can include a total of four mosaic patterns 541 of different touch electrodes 54. In addition, the region R1 can include the mosaic patterns 541 of four different touch electrodes 54 that are in an electrically independent state from each other. Similarly, the regions R2, R3, and R4 can include the mosaic patterns 541 of four different touch electrodes 54 that are in an electrically independent from each other.

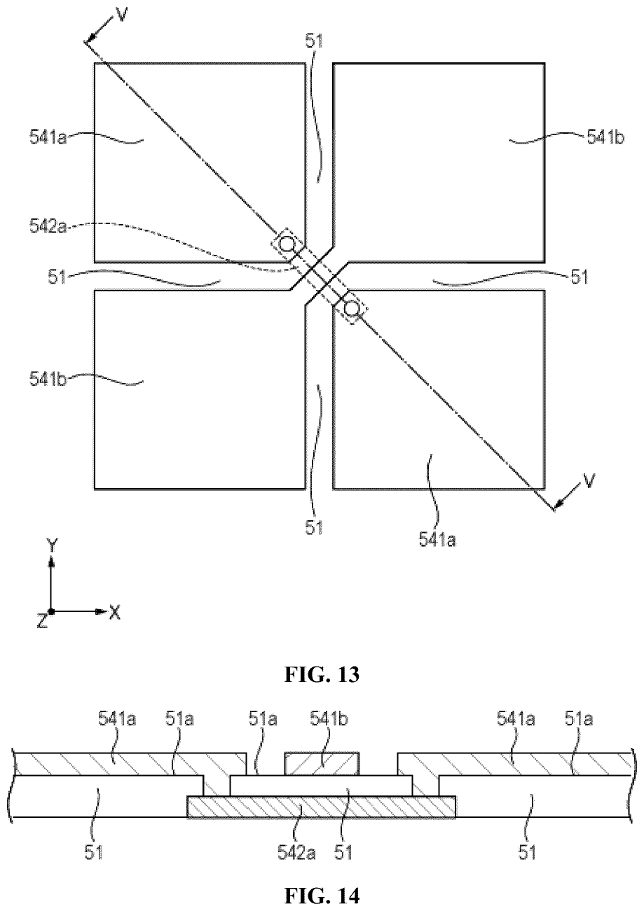

The mosaic pattern 541 of the touch electrode 54 can be divided into two layers and wired at the intersection portion Q (see FIG. 12) where it intersects with the mosaic pattern 541 of another touch electrode 54. FIG. 13 is an enlarged view of the intersection portion Q of FIG. 12, and FIG. 14 is a cross-sectional view of the line V-V of FIG. 13 according to one embodiment. The plurality of mosaic patterns 541 can be formed on the same layer (upper layer side) of the base member 51. That is, the mosaic pattern 541 and the other mosaic pattern 541 can be formed on the surface (same surface) 51a of the base member 51. At the intersection portion Q, adjacent electrode pieces 541a with the electrode piece 541b of the other mosaic pattern 541 interposed therebetween can be connected to each other through a bridge line 542a. The bridge line 542a can be formed across the electrode piece 541b of the other mosaic pattern 541, and can electrically connect the electrode piece 541a located on one side and the electrode piece 541a located on the other side with the other electrode piece 541b therebetween. The bridge line 542a can be formed on a lower layer side of the base member 51 than the electrode pieces 541a, and can be formed by bypassing the other electrode piece 541b. As such, the plurality of adjacent electrode pieces 541a of the mosaic pattern 541 can be connected to each other through the bridge line 542a formed in a layer different from the layer of the electrode pieces 541a at the intersection portion Q where they intersect with the other mosaic pattern 541.

The touch panel 50A can be configured with the plurality of touch electrodes 54 as described above, so that in the touch panel 50A, an area including at least three different touch electrodes 54 inside a circle with a diameter of 5 mm can occupy ½ or more of the entire touch panel 50A. In this case, the distance P indicating the interval between the touch electrodes 54 can be, for example, 7 mm, and the diagonal length L of the touch electrode 54 can be, for example, 19.5 mm.

Next, a comparison of the electric field intensity of the touch electrodes 54 according to the second embodiment and the electric field intensity of the touch electrodes 91 and 92 according to the comparative examples will be described.

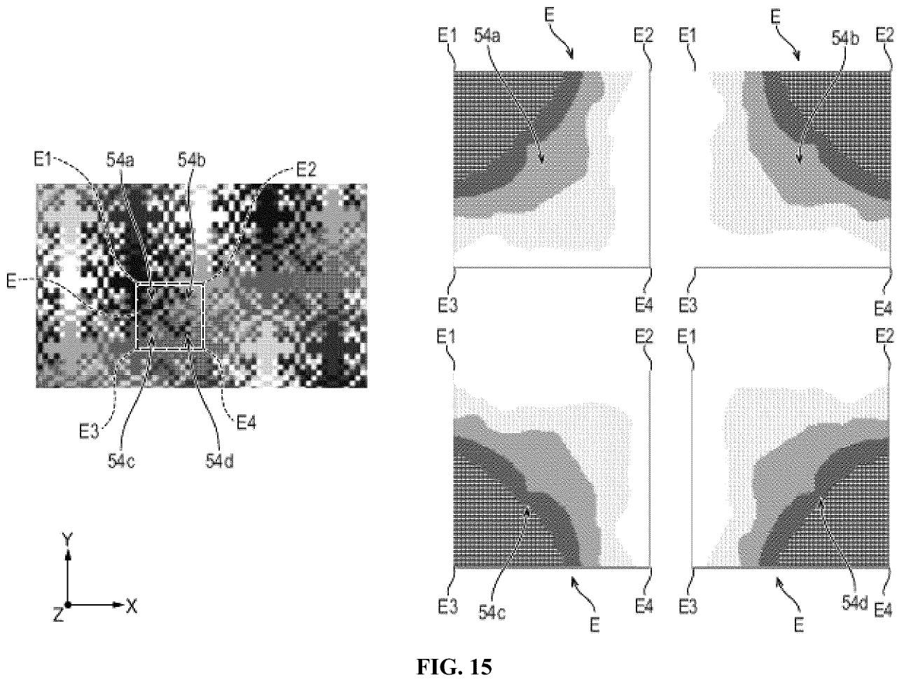

FIG. 15 is a view showing the electric field intensity of the touch electrodes 54 according to the second embodiment. The four drawings on the right side of FIG. 15 are drawings of enlarging the area E with respect to the touch electrodes 54a, 54b, 54c, and 54d of the drawing on the left side toward the paper surface. The area E can include parts of the four mosaic patterns 541 in the four touch electrodes 54a, 54b, 54c, and 54d. The touch electrode 54a located at the upper left of the area E can have an electric field distributed from the upper left to the lower right of the area E. The touch electrode 54b located at the upper right of the area E can have an electric field distributed from the upper right to the lower left of the area E. The touch electrode 54c located at the lower left of the area E can have an electric field distributed from the lower left to the upper right of the area E. The touch electrode 54d located at the lower right of the area E can have an electric field distributed from the lower right to the upper left of the area E.

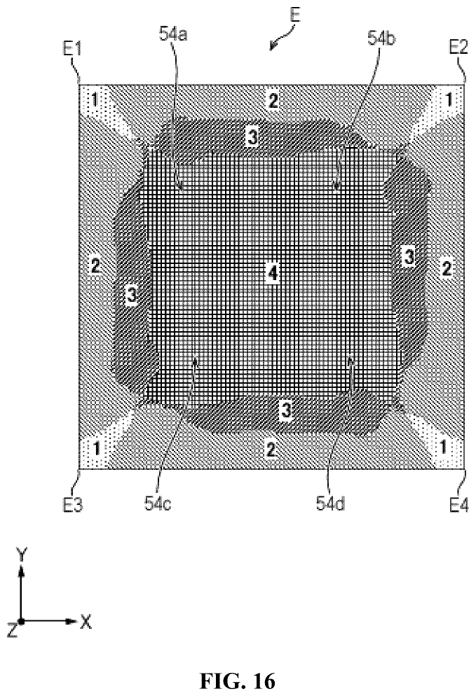

FIG. 16 is a view showing the number of touch electrodes 54 occupying a predetermined area according to the second embodiment. As shown in FIG. 16, the number of detectable touch electrodes 54 can be 3 to 4 over a wide range of the area E, compared to the touch electrodes 91 shown in FIG. 8 and the touch electrodes 92 shown in FIG. 10. As such, since the touch panel 50A according to the second embodiment includes three or more touch electrodes 54 over a wide range of the area E, the touch position can be detected in two dimensions, so that the touch position can be accurately detected.

As described above, the touch panel 50A according to the second embodiment can include the plurality of touch electrodes 54 arranged in a matrix shape in the X direction and the Y direction intersecting the X direction. The touch electrode 54 can have the length L that is 1.5 times or longer than the distance P between the touch electrode 54 and another touch electrode 54 adjacent thereto in the X direction or Y direction. This length L can be a length of the touch electrode 54 in the direction intersecting the X direction and the Y direction.

In this configuration, the touch panel 50A can extend the touch electrode 54 along the direction (diagonal direction) intersecting the X direction and the Y direction. By this, the touch panel 50A can include adjacent touch electrodes 54 in the common region not only in the X direction and the Y direction but also in the diagonal direction. By this, the touch panel 50A can increase the number of touch electrodes 54 included in the touch area without increasing the total number of touch electrodes 54 included in the touch panel 50A, and as a result, the touch position can be accurately detected.

In the touch panel 50A, the touch electrode 54 can include a pattern having the gap G in a plan view, and a part of the pattern of another touch electrode 54 adjacent thereto can be disposed in the gap G. By this configuration, the touch panel 50A can include the patterns of the plurality of touch electrodes 54 in the common region while being electrically independent from the patterns of another adjacent touch electrodes 54.

In the above touch panel 50A, the pattern can be the mosaic pattern 541 including the plurality of electrode pieces 541a of a predetermined shape. By this configuration, the touch panel 50A can include the patterns of the plurality of touch electrodes 54 in the common region.

In the above touch panel 50A, the electrode pieces 541a of another adjacent touch electrodes 54 can be disposed in the gap G of the mosaic pattern 541. By this configuration, the touch panel 50A can include the mosaic patterns 541 of the plurality of touch electrodes 52 in the common region while being electrically independent from the mosaic patterns 541 of another adjacent touch electrodes 54.

In the above touch panel 50A, the adjacent electrode pieces 541a of the mosaic pattern 541 can be connected to each other through the bridge line 542a formed in a layer different from the layer of the electrode pieces 541a. By this configuration, the touch panel 50A can be wired by crossing the mosaic pattern 541 with another mosaic pattern 541.

In the above touch panel 50A, the number of electrode pieces 541a per unit area can decrease as the distance from the center portion M of the touch electrode 54 increases. In this configuration, the touch panel 50A can increase the area ratio of the touch electrode 54 as it approaches the center portion M of the touch electrode 54. By this, the touch panel 50A can make the sensitivity of the center portion M of the touch electrode 54 higher than that of the peripheral portion of the touch electrode 54, and as a result, the touch position can be accurately detected.

In the above touch panel 50A, the area including at least three touch electrodes 54 inside a circle with a diameter of 5 mm can occupy ½ or more of the entire touch panel 50A. By this configuration, the touch panel 50A can increase the touch area including many touch electrodes 54, and as a result, the touch position can be accurately detected.

### Third Embodiment

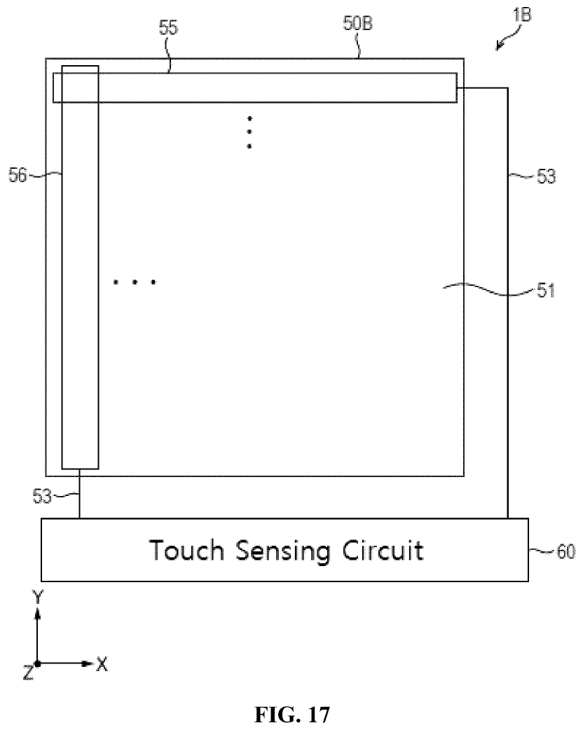

Next, a display device 1B according to a third embodiment will be described with respect to FIG. 17. The display device 1B according to the third embodiment can be different from the display device 1 according to the first embodiment in that it includes a mutual capacitance touch panel 50B that detects a decrease in inter-electrode capacitance when touched by a conductor such as a touch pen or a human finger. The display device 1B can include a touch panel 50B.

As shown in FIG. 17, the touch panel 50B can be configured to include a base member 51, a plurality of first touch electrodes 55, a plurality of second touch electrodes 56, a plurality of signal lines 53, and a touch driving circuit 61. In addition, FIG. 17 shows a schematic configuration of the first touch electrode 55 and the second touch electrode 56 in order to facilitate understanding of the invention.

The touch driving circuit 61 of the touch sensing circuit 60 can detect a change in capacitance (mutual capacitance) formed between the first touch electrode 55 and the second touch electrode 56. As shown in FIG. 17, the touch driving circuit 61 of the touch sensing circuit 60 can be connected to the first touch electrode 55 and the second touch electrode 56 through the signal lines 53. The touch driving circuit 61 can detect an inter-electrode voltage change or frequency change of the first touch electrode 55 and the second touch electrode 56 through the signal lines 53.

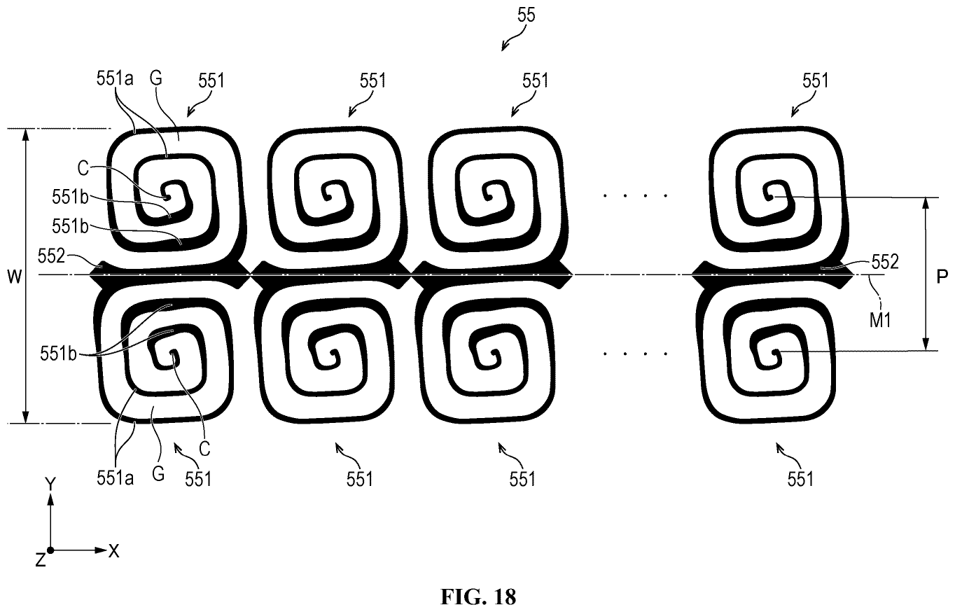

The first touch electrode 55 can be configured to include, for example, a plurality of spiral patterns 551 and a connecting pattern 552, as shown in FIG. 18.

The plurality of spiral patterns 551 can each be formed in the same spiral shape in a plan view. The plurality of spiral patterns 551 can be provided on both sides with the connecting pattern 552 extending in the X direction therebetween, and can be arranged in two rows along the X direction. That is, the plurality of spiral patterns 551 can be arranged in one row along the X direction on one side of the connecting pattern 552 in the Y direction, and can also be arranged in one row along the X direction on the other side of the connecting pattern 552 in the Y direction.

The line width of the spiral pattern 551 can be narrower as the distance from a center line M1 of the first touch electrode 55 in the Y direction increases. That is, the line width of the spiral pattern 551 can be wider as it approaches the center line M1 of the first touch electrode 55. In other words, the spiral pattern 551 can have a wide portion 551b formed with a wide width of its circumferential portion 551a, and this wide portion 551b can be located on the center line M1 side of the first touch electrode 55. Here, the center line M1 of the first touch electrode 55 can be a straight line that extends along the X direction and also passes through the center of the first touch electrode 55 in the Y direction.

The connecting pattern 552 can connect the plurality of spiral patterns 551. The connecting pattern 552 can extend along the X direction and can be arranged on the center line M1 between two rows of spiral patterns 551. In other words, the connecting pattern 552 can be arranged such that the spiral patterns 551 can be in one row along the X direction on one side and the spiral pattern 551 can also be arranged in one row along the X direction on the other side with the connecting pattern 552 therebetween. In addition, the connecting pattern 552 can connect two rows of the plurality of spiral patterns 551 and can electrically connect respective spiral patterns 551.

In the first touch electrode 55 configured as described above, a ratio of the conductive thin film per unit area of the center region including the center line M1 of the first touch electrode 55 can be greater than a ratio of the conductive thin film per unit area of the peripheral portion located around the center region. That is, the closer the first touch electrode 55 is to the center line M1, the higher the area ratio of the conductive thin film, and the farther away from the center line M1, the lower the area ratio of the conductive thin film. According to this, the first touch electrode 55 can have a higher sensitivity on the center line M1 side than on the peripheral portion of the first touch electrode 55, and as a result, the touch position can be accurately detected.

In this example, the spiral pattern 551 of the first touch electrode 55 can have the circumferential portion 551a extending spirally from the center C, as shown in FIG. 18, and a gap G can be provided between the inner circumferential portion 551a and the outer circumferential portion 551a. In the common region R, a part of the spiral pattern 551 of another first touch electrode 55 adjacent to the first touch electrode 55 and a part of a spiral pattern 561 of the second touch electrode 56 intersecting the first touch electrode 55 can be disposed in the gap G. That is, the circumferential portion 551a of another first touch electrode 55 and a circumferential portion 561a of another second touch electrode 56 can be disposed in the gap G between two adjacent circumferential portions 551a included in the spiral pattern 551.

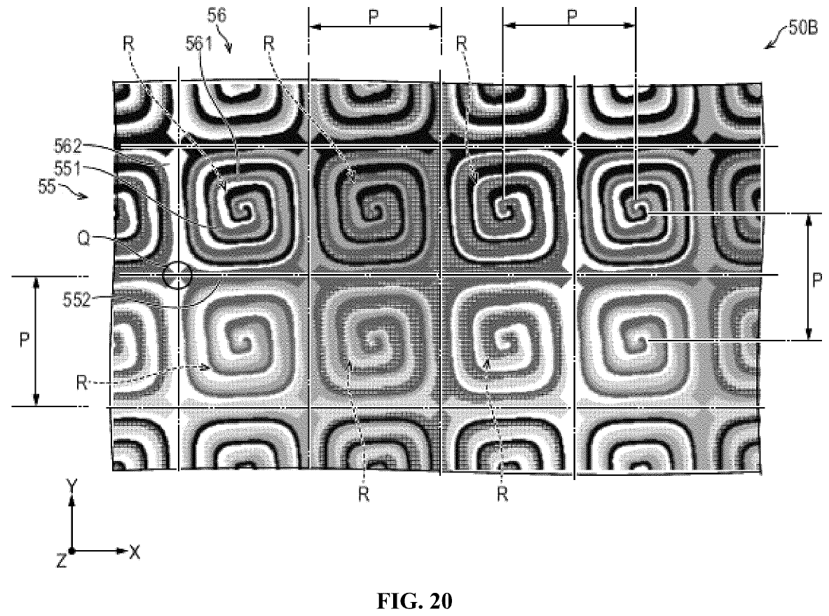

The plurality of first touch electrodes 55 can each extend along the X direction and also can each be arranged side by side along the Y direction with an interval of distance P, as shown in FIG. 20, for example. That is, the plurality of first touch electrodes 55 can each be an elongated electrode pattern extending along the X direction, and the elongated electrode patterns can be arranged side by side along the Y direction with the interval of distance P. The distance P can be an interval for arranging the plurality of first touch electrodes 55 along the Y direction. The plurality of first touch electrodes 55 can each be electrically independent. That is, each first touch electrode 55 may not be electrically connected to another first touch electrode 55 and the second touch electrode 56.

The width W of the first touch electrode 55 in the Y direction can be longer than the distance P between another adjacent first touch electrodes 55. That is, the maximum width W of the first touch electrode 55 including the two-row spiral patterns 551 in the Y direction can be longer than the distance P between another adjacent first touch electrodes 55. As such, the first touch electrode 55 can be formed to have a longer length in the Y direction than the distance P between another adjacent first touch electrodes 55. By this, the first touch electrode 55 can include another adjacent first touch electrodes 55 in the Y direction in the common region R. By this, the first touch electrode 55 can increase the number of first touch electrodes 55 included in the touch area, and as a result, the touch position can be accurately detected.

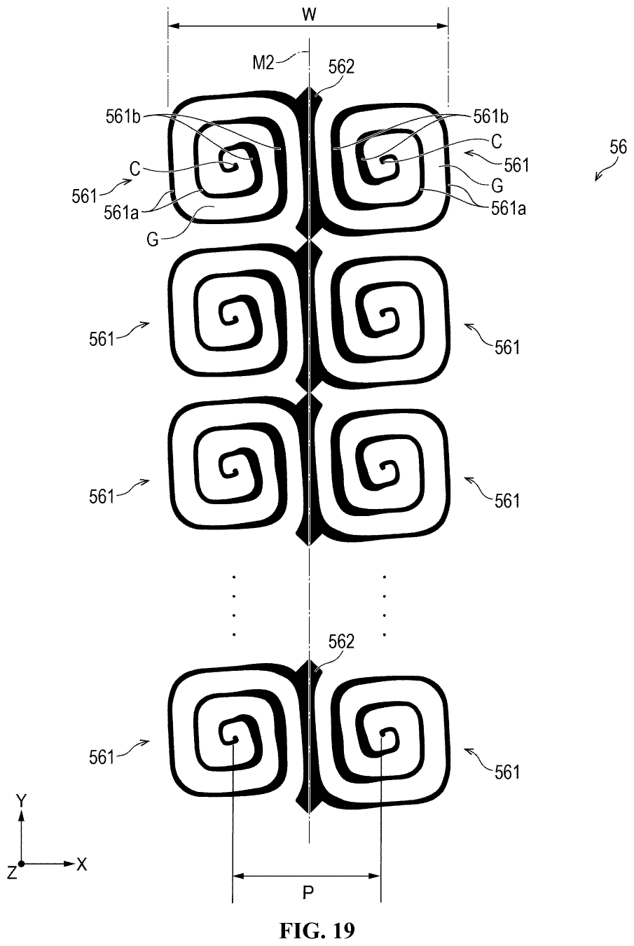

Next, the plurality of second touch electrodes 56 will be described. The second touch electrode 56 can be configured to include a plurality of spiral patterns 561 and a connecting pattern 562, as shown in FIG. 19, for example.

The plurality of spiral patterns 561 can each be formed in the same spiral shape in a plan view. The plurality of spiral patterns 561 can be provided on both sides with the connecting pattern 562 extending in the Y direction therebetween, and can be arranged in two rows along the Y direction. That is, the plurality of spiral patterns 561 can be arranged in one row along the Y direction on one side of the connecting pattern 562 in the X direction, and can also be arranged in one row along the Y direction on the other side of the connecting pattern 562 in the X direction.

The line width of the spiral pattern 561 can be narrower as the distance from a center line M2 of the second touch electrode 56 in the X direction increases. That is, the line width of the spiral pattern 561 can be wider as it approaches the center line M2 of the second touch electrode 56. In other words, the spiral pattern 561 can have a wide portion 561b formed with a wide width of its circumferential portion 561a, and this wide portion 561b can be located on the center line M2 side of the second touch electrode 56. Here, the center line M2 of the second touch electrode 56 can be a straight line that extends along the Y direction and also passes through the center of the second touch electrode 56 in the X direction.

The connecting pattern 562 can connect the plurality of spiral patterns 561. The connecting pattern 562 can extend along the Y direction and can be arranged on the center line M2 between two rows of spiral patterns 561. In other words, the connecting pattern 562 can be arranged such that the spiral patterns 561 can be in one row along the Y direction on one side and the spiral pattern 561 can also be arranged in one row along the Y direction on the other side with the connecting pattern 562 therebetween. In addition, the connecting pattern 562 can connect two rows of the plurality of spiral patterns 561 and can electrically connect respective spiral patterns 561.

In the second touch electrode 56 configured as described above, a ratio of the conductive thin film per unit area of the center region including the center line M2 of the second touch electrode 56 can be greater than a ratio of the conductive thin film per unit area of the peripheral portion located around the center region. That is, the closer the second touch electrode 56 is to the center line M2, the higher the area ratio of the conductive thin film, and the farther away from the center line M2, the lower the area ratio of the conductive thin film. According to this, the second touch electrode 56 can have a higher sensitivity on the center line M2 side than on the peripheral portion of the second touch electrode 56, and as a result, the touch position can be accurately detected.

As shown in FIG. 19, the spiral pattern 561 of the second touch electrode 56 can have the circumferential portion 561a extending spirally from the center C, and a gap G can be provided between the inner circumferential portion 561a and the outer circumferential portion 561a. In the common region R, a part of the spiral pattern 561 of another second touch electrode 56 adjacent to the second touch electrode 56 and a part of the spiral pattern 551 of the first touch electrode 55 intersecting the second touch electrode 56 can be disposed in the gap G. That is, the circumferential portion 551a of another first touch electrode 55 and the circumferential portion 561a of another second touch electrode 56 can be disposed in the gap G between two adjacent circumferential portions 561a included in the spiral pattern 561. In addition, the four spiral patterns 551 and 561 included in the common region R can each be electrically independent. As such, in the common region R, the four spiral patterns 551 and 561 can be included in a state in which each is electrically independent from other spiral patterns 551 and 561.

The plurality of second touch electrodes 56 can each extend along the Y direction and also can each be arranged side by side along the X direction with an interval of distance P, as shown in FIG. 20, for example. The plurality of second touch electrodes 56 can intersect the plurality of first touch electrodes 55. That is, the plurality of second touch electrodes 56 can each be an elongated electrode pattern extending along the Y direction, and the elongated electrode patterns can be arranged side by side along the X direction with the interval of distance P. The distance P can be an interval for arranging the plurality of second touch electrodes 56 along the X direction. The plurality of second touch electrodes 56 can each be electrically independent. That is, each second touch electrode 56 may not be electrically connected to another second touch electrode 56 and the first touch electrode 55.

The width W of the second touch electrode 56 in the X direction can be longer than the distance P between another adjacent second touch electrodes 56. That is, the maximum width W of the second touch electrode 56 including the two-row spiral patterns 561 in the X direction can be longer than the distance P between another adjacent second touch electrodes 56. As such, the second touch electrode 56 can be formed to have a longer length in the X direction than the distance P between another adjacent second touch electrodes 56. By this, the second touch electrode 56 can include another adjacent second touch electrodes 56 in the X direction in the common region R. By this, the second touch electrode 56 can increase the number of second touch electrodes 56 included in the region R, and as a result, the touch position can be accurately detected.

Here, the first touch electrode 55 can include another adjacent first touch electrodes 55 in the Y direction in the common region R, as described above. That is, the first touch electrode 55 can include two spiral patterns 551 of two first touch electrodes 55 adjacent to each other in the Y direction in the common region R. That is, the region R can include a total of two spiral patterns 511 in different first touch electrodes 55. In addition, the region R can include the spiral patterns 551 of two different first touch electrodes 55 in an electrically independent state.

In addition, the second touch electrode 56 can include another adjacent second touch electrodes 56 in the X direction in the common region R. That is, the second touch electrode 56 can include two spiral patterns 561 of two second touch electrodes 56 adjacent to each other in the X direction in the common region R. That is, the common region R can include a total of two spiral patterns 561 of two different second touch electrodes 56. In addition, the common region R can include the spiral patterns 561 of two different second touch electrodes 56 in an electrically independent state.

Thereafter, the common region R can also include the spiral patterns 551 of two first touch electrodes 55 and the spiral patterns 561 of two second touch electrodes 56 intersecting the two first touch electrodes 55. That is, the common region R can include the spiral patterns 551 of two different first touch electrodes 55, and can also include the spiral patterns 561 of two different second touch electrodes 56, so that the common region R can include a total of four different spiral patterns 551 and 561.

In addition, the plurality of spiral patterns 551 of the first touch electrodes 55 and the plurality of spiral patterns 561 of the second touch electrodes 56 can share the center C in the common region R. In other words, two spiral patterns 551 of two adjacent first touch electrodes 55 in the Y direction and two spiral patterns 561 of two adjacent second touch electrodes 56 in the X direction can be formed in a spiral shape around the common center C in the common region R and can each be electrically independent. That is, a total of four spiral patterns 551 and 561 including the two spiral patterns 551 of different first touch electrodes 55 and the two spiral patterns 561 of different second touch electrodes 56 can be formed in a spiral shape around the common center C and may not be connected to each other.

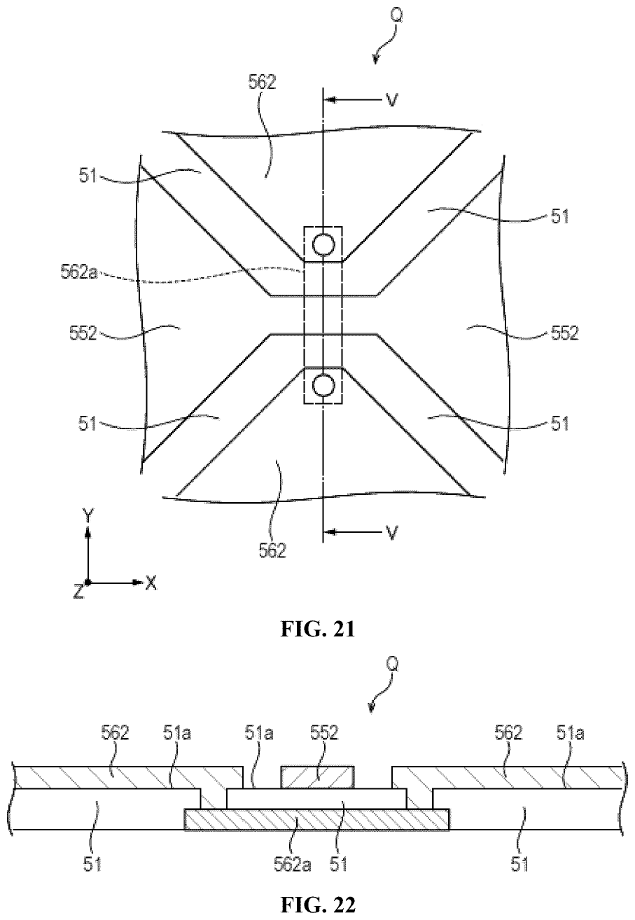

The second touch electrode 56 can be wired in two layers at the intersection portion Q (see FIG. 20) where it intersects with the first touch electrode 55. FIG. 21 is an enlarged view of the intersection portion Q of FIG. 20, and FIG. 22 is a cross-sectional view of the line V-V of FIG. 21. The first touch electrode 55 and the second touch electrode 56 can be formed on the same layer (upper layer side) of the base member 51. That is, the first touch electrode 55 and the second touch electrode 56 can be formed on the surface (same surface) 51a of the base member 51. At the intersection portion Q, the connecting patterns 562 of the second touch electrode 56 can be connected to each other via a bridge line 562a. The bridge line 562a can be formed across the connecting pattern 552 of the first touch electrode 55, and can connect the connecting pattern 562 located on one side and the connecting pattern 562 located on the other side with the connecting pattern 552 therebetween. The bridge line 562a can be formed on a lower layer side of the base member 51 than the connecting patterns 552 and 562, and can be formed by bypassing the connecting pattern 552.

The touch panel 50B can be configured with the first touch electrode 55 and the second touch electrode 56 as described above, so that in the touch panel 50B, an area including at least three first touch electrodes 55 or second touch electrodes 56 inside a circle with a diameter of 5 mm can occupy ½ or more of the entire touch panel 50B. In this case, the distance P indicating the interval between the first touch electrodes 55 can be, for example, 7 mm, and the width W of the first touch electrode 55 can be, for example, 13 mm. In addition, the distance P indicating the interval between the second touch electrodes 56 can be, for example, 7 mm, and the width W of the second touch electrode 56 can be, for example, 13 mm.

Next, a comparison of the electric field intensity in inter-electrode of the first touch electrode 55 and the second touch electrode 56 according to the third embodiment and the electric field intensity in inter-electrode of the first touch electrode 93 and 95 and the second touch electrode 94 and 96 according to the comparative examples will be described.

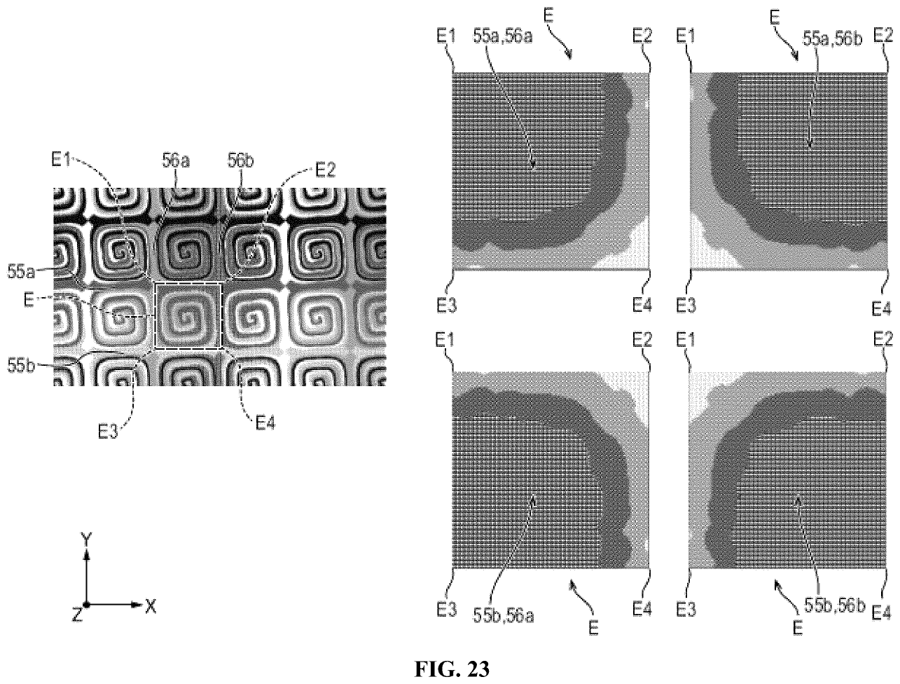

FIG. 23 is a view showing the electric field intensity in inter-electrode of the first touch electrode 55 and the second touch electrode 56 according to the third embodiment. The four drawings on the right side of FIG. 23 are drawings of enlarging the area E with respect to the inter-electrodes of the first touch electrodes 55a and 55b and the second touch electrodes 56a and 56b of the drawing on the left side toward the paper surface. The area E can include two spiral patterns 551 of two first touch electrodes 55a and 55b and two spiral patterns 561 of two second touch electrodes 56 and 56b. The inter-electrodes of the first touch electrode 55a and the second touch electrode 56a can be located at the upper left portion in the area E, and an electric field can be distributed from the upper left to the lower right of the area E. The inter-electrodes of the first touch electrode 55a and the second touch electrode 56b can be located at the upper right portion in the area E, and an electric field can be distributed from the upper right to the lower left of the area E. The inter-electrodes of the first touch electrode 55b and the second touch electrode 56a can be located at the lower left portion in the area E, and an electric field can be distributed from the lower left to the upper right of the area E. The inter-electrodes of the first touch electrode 55b and the second touch electrode 56b can be located at the lower right portion of the area E, and an electric field can be distributed from the lower right to the upper left of the area E.

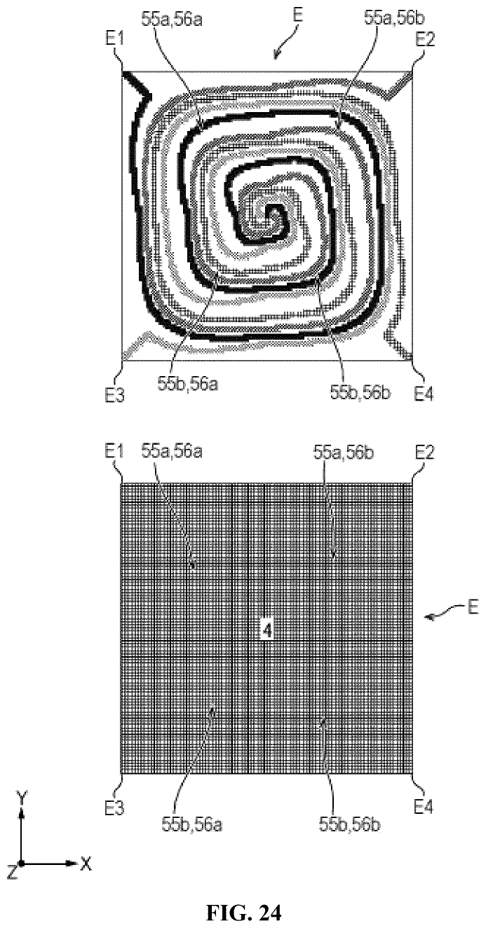

FIG. 24 is a view showing the number of inter-electrodes of each touch electrode 55 and 56 occupying a predetermined area according to the third embodiment. The upper drawing toward of FIG. 24 shows the boundary between the first touch electrode 55 and the second touch electrode 56. The lower drawing of FIG. 24 shows the number of inter-electrodes of each detectable touch electrode 55 and 56 in the area E as “1” to “4”. The number of inter-electrodes of each touch electrode 55 and 56 can be 4 over a wide range of the area E. As such, the touch panel 50B according to the third embodiment can include three or more inter-electrodes of each touch electrode 55 and 56 over a wide range of the area E, so that the touch position can be detected in two dimensions, and thereby the error between the actual touch position and the touch position data can be reduced. As a result of actually measuring the error, the average error in the XY coordinates between the actual touch position and the touch position data of the touch panel 50B according to the third embodiment is 0.026 mm, so that it can be seen that the error is small. As such, the touch panel 50B according to the third embodiment can increase the number of inter-electrodes of each touch electrode 55 and 56 included in the touch area, so that the touch position can be accurately detected.

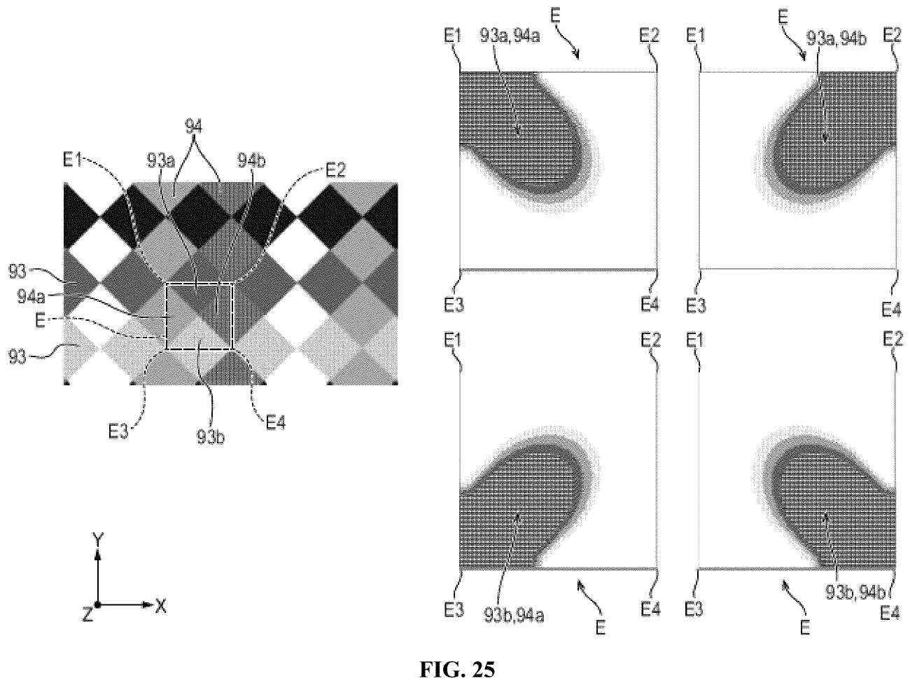

FIG. 25 is a view showing the electric field intensity in inter-electrode of the first touch electrode 93 and the second touch electrode 94 according to a comparative example. The first touch electrodes 93 shown in FIG. 25 are each formed in a rhombus shape and extend along the X direction. In addition, the second touch electrodes 94 shown in FIG. 25 are each formed in a rhombus shape and extend along the Y direction. The four drawings on the right side toward the paper surface of FIG. 25 are drawings of enlarging the area E with respect to the inter-electrodes of the first touch electrodes 93a and 93b and the second touch electrodes 94a and 94b of the drawing on the left side toward the paper surface. The area E includes two first touch electrodes 93a and 93b and two second touch electrodes 94a and 94b. The inter-electrodes of the first touch electrode 93a and the second touch electrode 94a are located at the upper left portion in the area E, and an electric field is distributed from the upper left to the lower right portion of the area E. The inter-electrodes of the first touch electrode 93a and the second touch electrode 94b are located at the upper right portion in the area E, and an electric field is distributed from the upper right to the lower left portion of the area E. The inter-electrodes of the first touch electrode 93b and the second touch electrode 94a are located at the lower left portion in the area E, and an electric field is distributed from the lower left to the upper right portion of the area E. The inter-electrodes of the first touch electrode 93b and the second touch electrode 94b are located at the lower right portion in the area E, and an electric field is distributed from the lower right to the upper left portion of the area E.

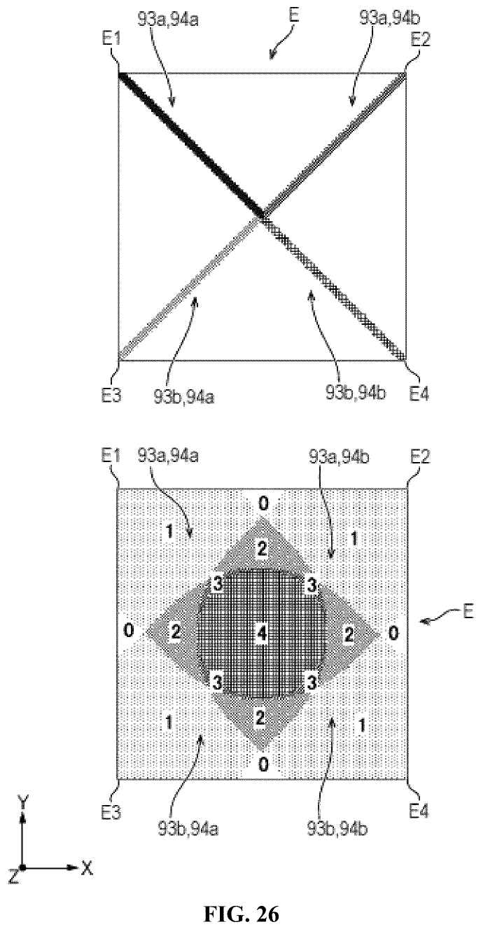

FIG. 26 is a view showing the number of inter-electrodes of each touch electrode 93 and 94 occupying a predetermined area according to the comparative example. The upper drawing toward the paper surface of FIG. 26 shows the boundary between the first touch electrode 93 and the second touch electrode 94. The lower drawing toward the paper surface of FIG. 26 shows the number of inter-electrodes of each detectable touch electrode 93 and 94 in the area E as “1” to “4”. In the center portion of the area E, the number of inter-electrodes of each touch electrode 93 and 94 is 3 to 4, but in the relatively wide peripheral portion of the area E, the number of inter-electrodes of each touch electrode 93 and 94 is 1 to 2. Due to this, when comparing each touch electrode 55 and 56 according to the third embodiment shown in FIG. 24, the area where the number of inter-electrodes of each touch electrode 93 and 94 is 3 to 4 is smaller than that in the third embodiment. As such, in the touch panel according to the comparative example, since the number of inter-electrodes of each touch electrode 93 and 94 included in the area E is smaller, the error between the actual touch position and the touch position data tends to increase. As a result of actually measuring the error, it can be seen that the touch panel according to the comparative example has an average error of 1.663 mm in the XY coordinates between the actual touch position and the touch position data, which is greater than the average error (0.026 mm) of each touch electrode 55 and 56 according to the third embodiment.

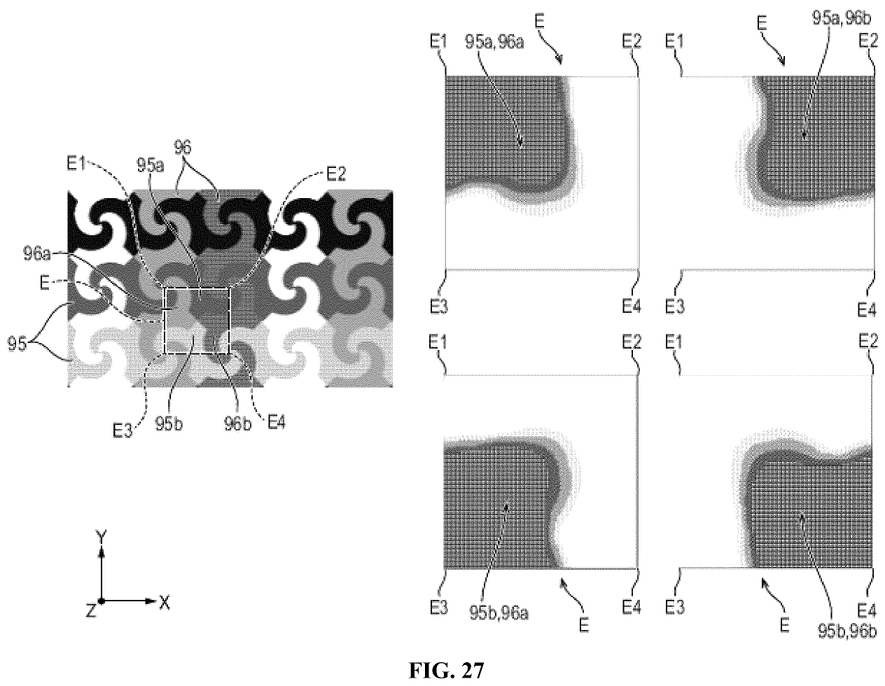

FIG. 27 is a view showing the electric field intensity in inter-electrode of the first touch electrode 95 and the second touch electrode 96 according to a comparative example. The first touch electrodes 95 shown in FIG. 27 are each formed in a predetermined curved shape and extend along the X direction. In addition, the second touch electrodes 96 shown in FIG. 27 are each formed in a predetermined curved shape and extend along the Y direction. The four drawings on the right side toward the paper surface of FIG. 27 are drawings of enlarging the area E with respect to the inter-electrodes of the first touch electrodes 95a and 95b and the second touch electrodes 96a and 96b of the drawing on the left side toward the paper surface. The area E includes two first touch electrodes 95a and 95b and two second touch electrodes 96a and 96b. The inter-electrodes of the first touch electrode 95a and the second touch electrode 96a are located at the upper left portion in the area E, and an electric field is distributed from the upper left to the lower right portion of the area E. The inter-electrodes of the first touch electrode 95a and the second touch electrode 96b are located at the upper right portion in the area E, and an electric field is distributed from the upper right to the lower left portion of the area E. The inter-electrodes of the first touch electrode 95b and the second touch electrode 96a are located at the lower left portion in the area E, and an electric field is distributed from the lower left to the upper right portion of the area E. The inter-electrodes of the first touch electrode 95b and the second touch electrode 96b are located at the lower right portion in the area E, and an electric field is distributed from the lower right to the upper left portion of the area E.

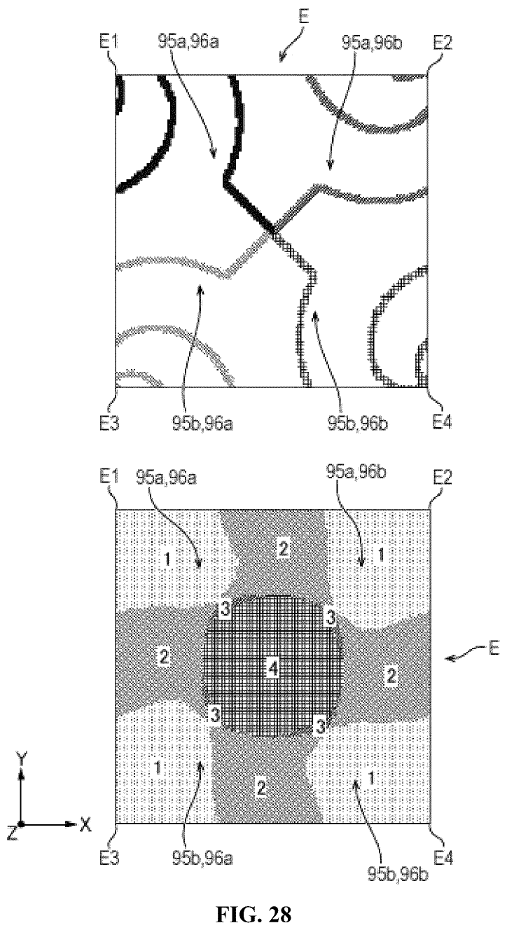

FIG. 28 is a view showing the number of inter-electrodes of each touch electrode 95 and 96 occupying a predetermined area according to the comparative example. The upper drawing toward the paper surface of FIG. 28 shows the boundary between the first touch electrode 95 and the second touch electrode 96. The lower drawing toward the paper surface of FIG. 28 shows the number of inter-electrodes of each detectable touch electrode 95 and 96 in the area E as “1” to “4”. In the center portion of the area E, the number of inter-electrodes of each touch electrode 95 and 96 is 3 to 4, but in the relatively wide peripheral portion of the area E, the number of inter-electrodes of each touch electrode 95 and 96 is 1 to 2. Due to this, when comparing each touch electrode 55 and 56 according to the third embodiment shown in FIG. 24, the area where the number of inter-electrodes of each touch electrode 95 and 96 is 3 to 4 is smaller than that in the third embodiment, and therefore, it is thought that it is difficult to accurately detect the touch position.

As described above, the touch panel 50B according to the third embodiment can include the plurality of first touch electrodes 55 each extending in the X direction and the plurality of second touch electrodes 56 each extending in the Y direction intersecting the X direction. The width W of the first touch electrode 55 in the Y direction can be longer than the distance P between another adjacent first touch electrodes 55. The width W of the second touch electrode 56 in the X direction can be longer than the distance P between another adjacent second touch electrodes 56.

By this configuration, the touch panel 50B can include adjacent first touch electrodes 55 in the common region R and can also include adjacent second touch electrodes 56 in the common region R. By this, the touch panel 50B can increase the number of each touch electrode 55 and 56 included in the touch area without increasing the total number of each touch electrode 55 and 56 included in the touch panel 50B, and as a result, the touch position can be accurately detected.

In the touch panel 50B, each of the first touch electrode 55 and the second touch electrode 56 can include a pattern having the gap G in a plan view. In the gap G of the first touch electrode 55, a part of the pattern of another first touch electrode 55 adjacent to the first touch electrode 55 and a part of the pattern of the second touch electrode 56 intersecting the first touch electrode 55 can be disposed. In the gap G of the second touch electrode 56, a part of the pattern of another second touch electrode 56 adjacent to the second touch electrode 56 and a part of the pattern of the first touch electrode 55 intersecting the second touch electrode 56 can be disposed. By this configuration, the touch panel 50B can include the patterns of the plurality of first touch electrodes 55 and the patterns of the plurality of second touch electrodes 56 in the common region R while being electrically independent from each other.

In the above touch panel 50B, the pattern can be the spiral pattern 551 and 561 extending spirally from the predetermined center C in a plan view. By this configuration, the touch panel 50B can include the patterns of the plurality of first touch electrodes 55 and the patterns of the plurality of second touch electrodes 56 in the common region R.

In the above touch panel 50B, the plurality of spiral patterns 551 and 561 of the first touch electrode 55 and the second touch electrode 56 adjacent to each other can share the center C. By this configuration, the touch panel 50B can efficiently include the patterns of each touch electrode 55 and 56 in the common region R.

In the above touch panel 50B, respective circumferential portions 551a and 561a of another first touch electrode 55 and another second touch electrode 56 can be disposed in the gap G between the two adjacent circumferential portions 551a included in the spiral pattern 551. In addition, respective circumferential portions 551a and 561a of another first touch electrode 55 and another second touch electrode 56 can be disposed in the gap G between the two adjacent circumferential portions 561a included in the spiral pattern 561. By this configuration, the touch panel 50B can include the spiral pattern 551 of the first touch electrode 55 and the spiral pattern 561 of the second touch electrode 56 in the common region R while being electrically independent.

In the above touch panel 50B, the first touch electrode 55 can have the plurality of spiral patterns 551 arranged in two rows and the connecting pattern 552 arranged on the center line M1 between the two rows and connecting the two rows of the plurality of spiral patterns 551. The second touch electrode 56 can have the plurality of spiral patterns 561 arranged in two rows and the connecting pattern 562 arranged on the center line M2 between the two rows and connecting the two rows of the plurality of spiral patterns 561. By this configuration, the touch panel 50B can electrically connect the plurality of spiral patterns 551 by the connecting pattern 552 and can electrically connect the plurality of spiral patterns 561 by the connecting pattern 562.

In the above touch panel 50B, the line width of the spiral pattern 551 can be formed to be narrower as the distance from the center line M1 increases, and the line width of the spiral pattern 561 can be formed to be narrower as the distance from the center line M2 increases. By this configuration, the touch panel 50B can increase the area ratio of the first touch electrode 55 as it gets closer to the center line M1 of the first touch electrode 55, and can increase the area ratio of the second touch electrode 56 as it gets closer to the center line M2 of the second touch electrode 56. By this, the touch panel 50B can have a higher sensitivity on the side of the center lines M1 and M2 than on the peripheral portions of the first touch electrode 55 and the second touch electrode 56, and as a result, the touch position can be detected accurately.

In the above touch panel 50B, the area including at least three first touch electrodes 55 or second touch electrodes 56 inside a circle with a diameter of 5 mm can occupy ½ or more of the entire touch panel 50B. By this configuration, the touch panel 50B can increase the touch area including many touch electrodes 55 and 56, and as a result, the touch position can be accurately detected.

### Fourth Embodiment

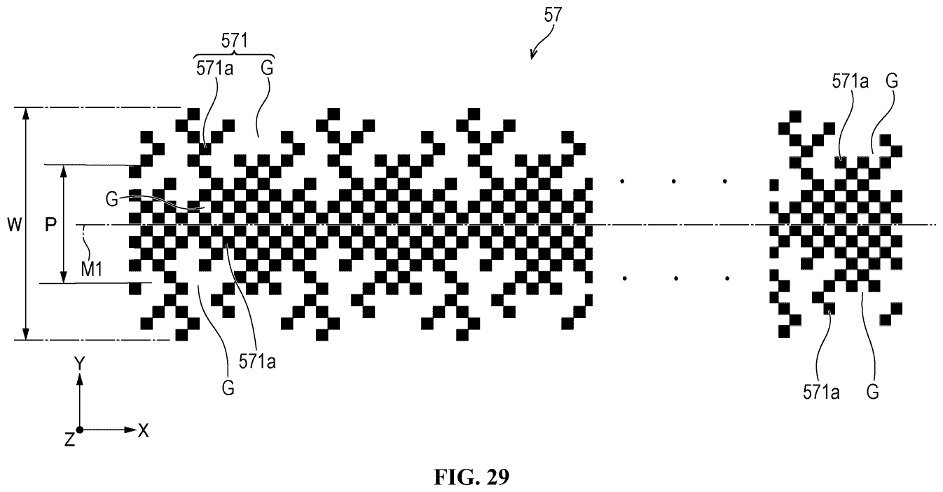

Next, a touch panel 50C according to a fourth embodiment will be described with respect to FIG. 29. The touch panel 50C according to the fourth embodiment can be different from the touch panel 50B according to the third embodiment in that the pattern of each touch electrode 55 and 56 can be a mosaic pattern.

The touch panel 50C can be a mutual capacitance touch panel that detects a decrease in inter-electrode capacitance when touched by a conductor such as a touch pen or a human finger. The touch panel 50C can be configured to include a plurality of first touch electrodes 57 and a plurality of second touch electrodes 58. The first touch electrode 57 can be configured to include a mosaic pattern 571, as shown in FIG. 29, for example.

The mosaic pattern 571 can be a pattern including a plurality of electrode pieces 571a of a predetermined shape. For example, the electrode pieces 571a of the mosaic pattern 571 can be formed in a rectangular shape, and each electrode piece 571a can be arranged so as to have a predetermined shape. The mosaic pattern 571 can include the plurality of electrode pieces 571a and a plurality of gaps G, and the electrode pieces 571a can be electrically connected to each other. In the gap G of the mosaic pattern 571, the electrode piece 571a of another adjacent first touch electrode 57 and an electrode piece 581a of another adjacent second touch electrode 58 can be disposed.

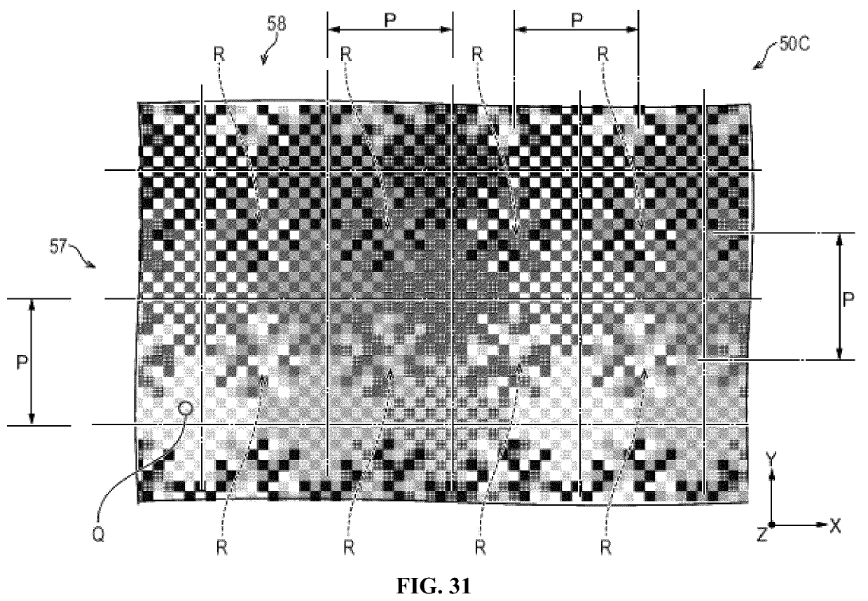

As shown in FIG. 31, the plurality of first touch electrodes 57 can each extend along the X direction, and also can each be arranged side by side along the Y direction with an interval of distance P. That is, the plurality of first touch electrodes 57 can each be an elongated electrode pattern extending along the X direction, and the elongated electrode patterns can be arranged side by side along the Y direction with the interval of distance P. The distance P can be an interval for arranging the plurality of first touch electrodes 57 along the Y direction. The plurality of first touch electrodes 57 can each be electrically independent. That is, each first touch electrode 57 may not be electrically connected to another first touch electrode 57 and the second touch electrode 58.

The width W of the first touch electrode 57 in the Y direction can be longer than the distance P between another adjacent first touch electrodes 57. That is, the maximum width W of the first touch electrode 57 including the mosaic pattern 571 in the Y direction can be longer than the distance P between another adjacent first touch electrodes 57. As such, the first touch electrode 57 can be formed to have a longer length in the Y direction than the distance P between another adjacent first touch electrodes 57. By this, the first touch electrode 57 can include another adjacent first touch electrodes 57 in the Y direction in the common region R. By this, the first touch electrode 57 can increase the number of first touch electrodes 57 included in the touch area, and as a result, the touch position can be accurately detected.

The number of electrode pieces 571a per unit area of the mosaic pattern 571 can decrease as the distance from the center line M1 of the mosaic pattern 571 in the Y direction increases. That is, the number of electrode pieces 571a per unit area of the mosaic pattern 571 can increase as the distance from the center line M1 of the mosaic pattern 571 decreases. In other words, the closer the mosaic pattern 571 is to the center line M1, the higher the area ratio of the conductive thin film, and the farther from the center line M1, the lower the area ratio of the conductive thin film. Therefore, the first touch electrode 57 having the mosaic pattern 571 can have the sensitivity on the center line M1 side higher than that on the peripheral portion of the first touch electrode 57, and as a result, the touch position can be accurately detected. Here, the center line M1 can be a straight line that extends along the X direction and also passes through the center of the first touch electrode 57 in the Y direction.

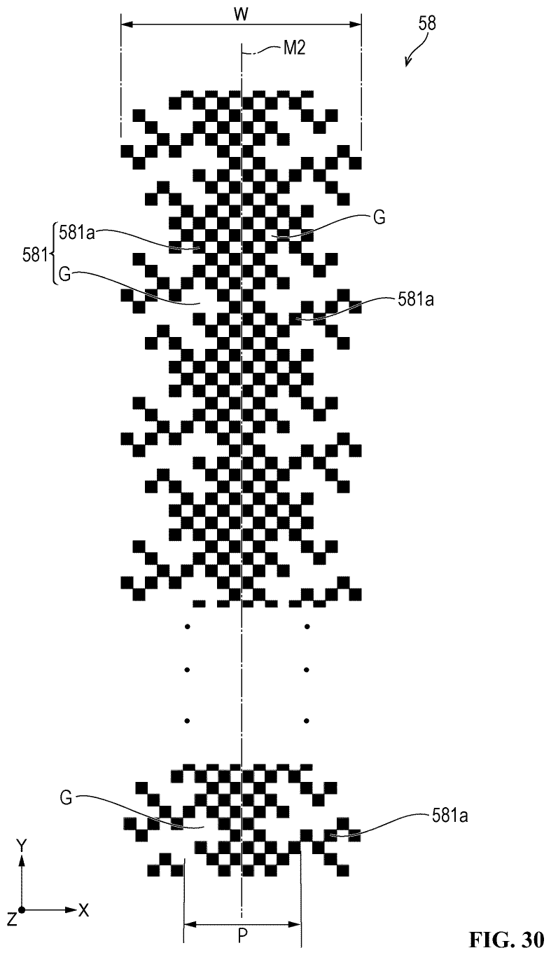

Next, the plurality of second touch electrodes 58 will be described. The second touch electrode 58 can be configured to include a mosaic pattern 581, as shown in FIG. 30, for example.

The mosaic pattern 581 can be a pattern including a plurality of electrode pieces 581a of a predetermined shape. For example, the electrode pieces 581a of the mosaic pattern 581 can be formed in a rectangular shape, and each electrode piece 581a can be arranged so as to have a predetermined shape. The mosaic pattern 581 can include the plurality of electrode pieces 581a and a plurality of gaps G, and the electrode pieces 581a can be electrically connected to each other. In the gap G of the mosaic pattern 581, the electrode piece 581a of another adjacent second touch electrode 58 and the electrode piece 571a of another adjacent first touch electrode 57 can be disposed.

As shown in FIG. 31, the plurality of second touch electrodes 58 can each extend along the Y direction, and also can each be arranged side by side along the X direction with an interval of distance P. That is, the plurality of second touch electrodes 58 can each be an elongated electrode pattern extending along the Y direction, and the elongated electrode patterns can be arranged side by side along the X direction with the interval of distance P. The distance P can be an interval for arranging the plurality of second touch electrodes 58 along the X direction. The plurality of second touch electrodes 58 can each be electrically independent. That is, each second touch electrode 58 may not be electrically connected to another second touch electrode 58 and the first touch electrode 57.

The width W of the second touch electrode 58 in the X direction can be longer than the distance P between another adjacent second touch electrodes 58. That is, the maximum width W of the second touch electrode 58 including the mosaic pattern 581 in the X direction can be longer than the distance P between another adjacent second touch electrodes 58. As such, the second touch electrode 58 can be formed have a longer length in the X direction than the distance P between another adjacent second touch electrodes 58. By this, the second touch electrode 58 can include another adjacent second touch electrodes 58 in the X direction in the common region R. By this, the second touch electrode 58 can increase the number of second touch electrodes 58 included in the touch area, and as a result, the touch position can be accurately detected.

The number of electrode pieces 581a per unit area of the mosaic pattern 581 can decrease as the distance from the center line M2 of the mosaic pattern 581 in the X direction increases. That is, the number of electrode pieces 581a per unit area of the mosaic pattern 581 can decrease as the distance from the center line M2 of the mosaic pattern 581 decreases. In other words, the closer the mosaic pattern 581 is to the center line M2, the higher the area ratio of the conductive thin film, and the farther from the center line M2, the lower the area ratio of the conductive thin film. Therefore, the second touch electrode 58 having the mosaic pattern 581 can have a higher sensitivity on the center line M2 side than on the peripheral portion of the second touch electrode 588, and as a result, the touch position can be accurately detected. Here, the center line M2 can be a straight line that extends along the Y direction and also passes through the center of the second touch electrode 58 in the X direction.

Here, as described above, the first touch electrode 57 can include another adjacent first touch electrodes 57 in the Y direction in the common region R. That is, the first touch electrode 57 can include two mosaic patterns 571 of two first touch electrodes 57 adjacent to each other in the Y direction in the common region R. That is, the region R can include a total of two mosaic patterns 571 of different first touch electrodes 57. In addition, the region R can include the mosaic patterns 571 of two different first touch electrodes 57 in an electrically independent state.

Similarly, the second touch electrode 58 can include another adjacent second touch electrodes 58 in the X direction in the common region R. That is, the second touch electrode 58 can include two mosaic patterns 581 of two second touch electrodes 58 adjacent to each other in the X direction in the common region R. That is, the region R can include a total of two mosaic patterns 581 of different second touch electrodes 58. In addition, the region R can include the mosaic patterns 581 of two different second touch electrodes 58 in an electrically independent state.

Thereafter, the common region R can also include the mosaic patterns 571 of two first touch electrodes 57 and the mosaic patterns 581 of two second touch electrodes 58 intersecting the two first touch electrodes 57. That is, the common region R can include the mosaic patterns 571 of two different first touch electrodes 57 and can also include the mosaic patterns 581 of two different second touch electrodes 58, so that the common region R can include a total of four different mosaic patterns 571 and 581. At this time, in the gap G of the mosaic pattern 571 of the first touch electrode 57, the electrode piece 571a of another adjacent first touch electrode 57 and the electrode piece 581a of another adjacent second touch electrode 58 can be disposed. In addition, in the gap G of the mosaic pattern 581 of the second touch electrode 58, the electrode piece 581a of another adjacent second touch electrode 58 and the electrode piece 571a of another adjacent first touch electrode 57 can be disposed. And, in the common region R, the four mosaic patterns 571 and 581 can each be electrically independent. That is, the four mosaic patterns 571 and 581 may not be connected to each other. As such, in the common region R, the four mosaic patterns 571 and 581 can each be included in an electrically independent state.

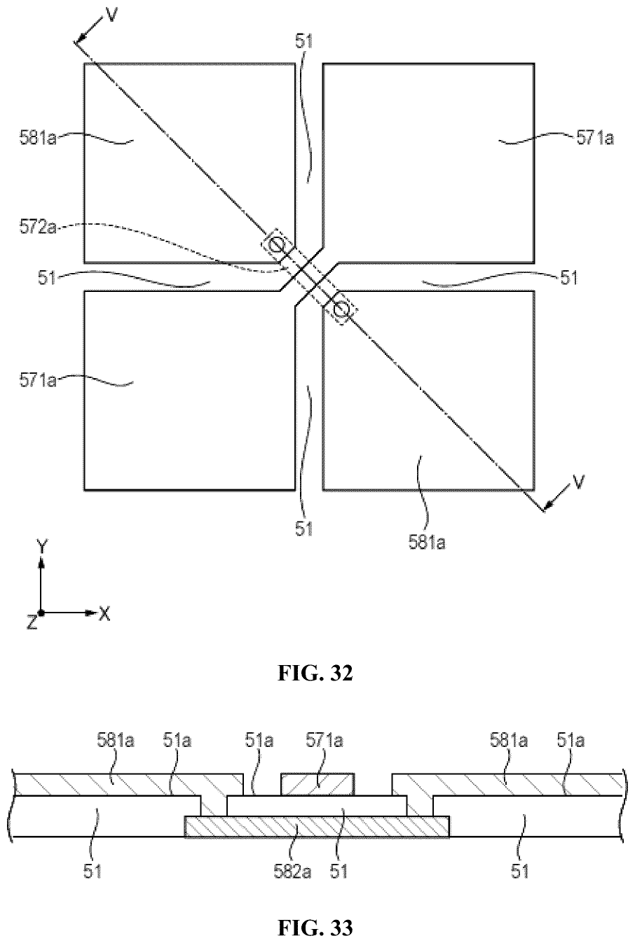

The mosaic pattern 581 of the second touch electrode 58 can be divided into two layers and wired at the intersection portion Q (see FIG. 31) where it intersects with the mosaic pattern 571 of the first touch electrode 57. FIG. 32 is an enlarged view of the intersection portion Q of FIG. 31, and FIG. 33 is a cross-sectional view of the line V-V of FIG. 32. The mosaic pattern 571 and the mosaic pattern 581 can be formed on the same layer (upper layer side) of the base member 51. That is, the mosaic pattern 571 and the mosaic pattern 581 can be formed on the surface (same surface) 51a of the base member 51. At the intersection portion Q, adjacent electrode pieces 581a with the electrode piece 571a of the mosaic pattern 571 interposed therebetween can be connected through a bridge line 582a. The bridge line 582a can be formed across the electrode piece 571a of the mosaic pattern 571, and can electrically connect the electrode piece 581a positioned on one side and the electrode piece 581a positioned on the other side with the electrode piece 571a interposed therebetween. The bridge line 582a can be formed on a lower layer side of the base member 51 than the electrode pieces 571a and 581a, and can be formed by bypassing the electrode piece 571a. As such, the plurality of adjacent electrode pieces 581a of the mosaic pattern 581 can be connected to each other through the bridge line 582a formed in a layer different from the layer of the electrode pieces 581a at the intersection portion Q where they intersect with the other mosaic pattern 571.

By configuring the first touch electrode 57 and the second touch electrode 58 as described above, in the touch panel 50C, an area including at least three first touch electrodes 57 or second touch electrodes 58 inside a circle having a diameter of 5 mm can occupy ½ or more of the entire touch panel 50C. In this case, the distance P indicating the interval between the first touch electrodes 57 can be, for example, 7 mm, and the width W of the first touch electrode 57 can be, for example, 13 mm. In addition, the distance P indicating the interval between the second touch electrodes 58 can be, for example, 7 mm, and the width W of the second touch electrodes 58 can be, for example, 13 mm.

Next, a comparison of the electric field intensity in inter-electrode of the first touch electrode 57 and the second touch electrode 58 according to the fourth embodiment and the electric field intensity in inter-electrode of the first touch electrode 93 and 95 and the second touch electrode 94 and 96 according to the comparative examples will be described.

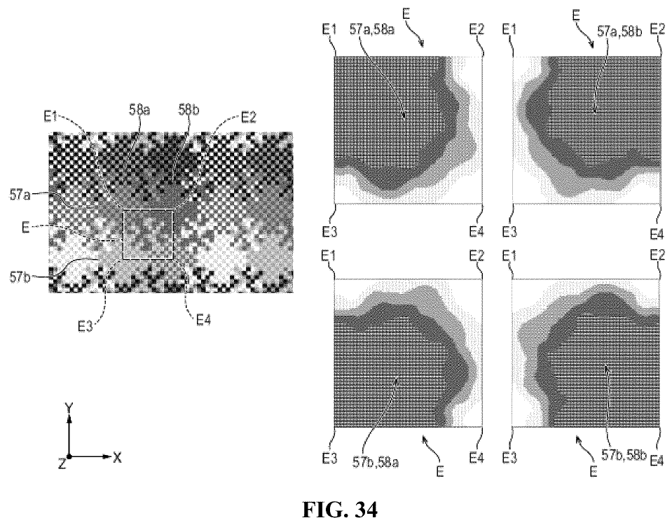

FIG. 34 is a view showing the electric field intensity in inter-electrode of the first touch electrode 57 and the second touch electrode 58 according to the fourth embodiment. The four drawings on the right side toward the paper surface of FIG. 34 are drawings of enlarging the area E with respect to the inter-electrodes of the first touch electrode 57a and 57b and the second touch electrode 58a and 58b of the drawing on the left side toward the paper surface. The area E can include two mosaic patterns 571 of two first touch electrodes 57a and 57b and two mosaic patterns 581 of two second touch electrodes 58a and 58b. The inter-electrodes of the first touch electrode 57a and the second touch electrode 58a can be located at the upper left portion in the area E, and an electric field can be distributed from the upper left to the lower right portion of the area E. The inter-electrodes of the first touch electrode 57a and the second touch electrode 58b can be located at the upper right portion in the area E, and an electric field can be distributed from the upper right to the lower left portion of the area E. The inter-electrodes of the first touch electrode 57b and the second touch electrode 58a can be located at the lower left portion in the area E, and an electric field can be distributed from the lower left to the upper right portion of the area E. The inter-electrodes of the first touch electrode 57b and the second touch electrode 58b can be located in the lower right portion of the area E, and an electric field can be distributed from the lower right to the upper left of the area E.

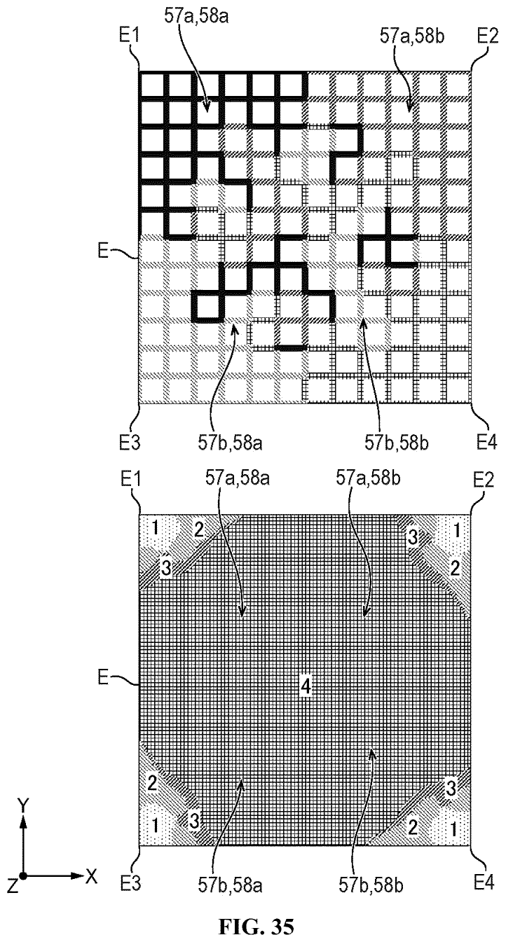

FIG. 35 is a view showing the number of inter-electrodes of each touch electrode 57 and 58 occupying a predetermined area according to the fourth embodiment. The upper drawing toward the paper surface of FIG. 35 shows the boundary between the first touch electrode 57 and the second touch electrode 58. The lower drawing toward the paper surface of FIG. 35 shows the number of inter-electrodes of the detectable touch electrode 57 and 58 in the area E as “1” to “4”. Compared to each touch electrode 93, 94, 95, and 96 shown in FIG. 26 and FIG. 28, the number of inter-electrodes of the touch electrode 57 and 58 can be 3 or 4 over a wide range of the area E. As such, the touch panel 50C according to the fourth embodiment can include three or more inter-electrodes of the touch electrode 57 and 58 over a wide range of the area E, so that the touch position can be detected in two dimensions, and thereby the touch position can be accurately detected.

As described above, the touch panel 50C according to the fourth embodiment can include the plurality of first touch electrodes 57 each extending in the X direction and the plurality of second touch electrodes 58 each extending in the Y direction intersecting the X direction. The width W of the first touch electrode 57 in the Y direction can be longer than the distance P between another adjacent first touch electrodes 57. The width W of the second touch electrode 58 in the X direction is longer than the distance P between another adjacent second touch electrodes 58.

By this configuration, the touch panel 50C can include adjacent first touch electrodes 57 in the common region R and can also include adjacent second touch electrodes 58 in the common region R. By this, the touch panel 50C can increase the number of each touch electrode 57 and 58 included in the touch area without increasing the total number of each touch electrode 57 and 58 included in the touch panel 50C, and as a result, the touch position can be accurately detected.

In the above touch panel 50C, the pattern can be mosaic pattern 571 and 581 including the plurality of electrode pieces 571a and 581a of a predetermined shape. By this configuration, the touch panel 50C can include the patterns of the plurality of first touch electrodes 57 and the patterns of the plurality of second touch electrodes 58 in the common region R.

In the above touch panel 50C, the electrode piece 571a of another adjacent first touch electrode 57 and the electrode piece 581a of another adjacent second touch electrode 58 can be arranged in the gap G of the mosaic pattern 571. By this configuration, the touch panel 50C can include the mosaic pattern 571 of the first touch electrode 57 and the mosaic pattern 581 of the second touch electrode 58 in the common region R while being electrically independent.

In the above touch panel 50C, adjacent electrode pieces 581a of the mosaic pattern 581 can be connected to each other through the bridge line 582a formed in a layer different from the layer of the electrode pieces 581a. By this configuration, the touch panel 50C can be wired by intersecting the mosaic pattern 581 and the mosaic pattern 571.

In the above touch panel 50C, the number of electrode pieces 571a per unit area can decrease as the distance from the center line M1 of the first touch electrode 57 increases. In addition, the number of the electrode pieces 581a per unit area can decrease as the distance from the center line M2 of the second touch electrode 58 increases. By this configuration, the touch panel 50C can make the area ratio of the first touch electrode 57 higher as it gets closer to the center line M1 of the first touch electrode 57, and can make the area ratio of the second touch electrode 58 higher as it gets closer to the center line M2 of the second touch electrode 58. As a result, the touch panel 50C can make the sensitivity of the center lines M1 and M2 side higher than that of the peripheral portions of the first touch electrode 57 and the second touch electrode 58, and as a result, the touch position can be detected accurately.

In the above touch panel 50C, an area including at least three first touch electrodes 57 or second touch electrodes 58 inside a circle with a diameter of 5 mm can occupy ½ or more of the entire touch panel 50C. By this configuration, the touch panel 50C can increase the touch area including many touch electrodes 57 and 58, and as a result, a touch position can be accurately detected.

In addition, in the above description, the example in which in the touch panel 50, the touch electrode 52 is divided into four regions R1, R2, R3, and R4 has been described, but embodiments of the present disclosure are not limited thereto. In other embodiments, the touch electrode 52 may be divided into a number of regions other than four.

In addition, in the touch panel 50, the example in which the plurality of spiral patterns 521 share the center C has been described, but embodiments of the present disclosure are not limited thereto. In other embodiments, the plurality of spiral patterns 521 may not share the center C.

In addition, in the touch panel 50, the example in which the line width of each of the spiral pattern 521 and the connecting pattern 522 is formed to be narrower as the distance from the center M increases has been described, but embodiments of the present disclosure are not limited thereto. In other embodiments, for example, the same line width may be used.

In addition, in the touch panel 50A, the example in which the plurality of electrode pieces 541a are connected to each other through the bridge line 542a formed in a layer different from the layer of the electrode pieces 541a has been described, but embodiments of the present disclosure are not limited thereto. In other embodiments, the plurality of electrode pieces 541a may be connected by a method different from the bridge line 542a.

In addition, in the touch panel 50A, the example in which the number of the electrode pieces 541a per unit area decreases as the distance from the center portion M of the touch electrode 54 increases has been described, but embodiments of the present disclosure are not limited thereto. In other embodiments, for example, the number may be the same regardless of the distance from the center portion M.

In addition, in the touch panel 50B, the example in which the plurality of spiral patterns 551 and 561 of adjacent first touch electrodes 55 and second touch electrodes 56 share the center C has been described, but embodiments of the present disclosure are not limited thereto. In other embodiments, for example, the center C may not be shared.

In addition, in the touch panel 50B, it has been described as the example in which the line width of the spiral pattern 551 is formed to be narrower as the distance from the center line M1 increases, and the line width of the spiral pattern 561 is formed to be narrower as the distance from the center line M2 increases. However, embodiments of the present disclosure are not limited thereto. In other embodiments, for example, the same line width may be used.

In addition, in the touch panel 50C, the example in which adjacent electrode pieces 581a of the mosaic pattern 581 are connected to each other through the bridge line 582a formed in a layer different from the layer of the electrode pieces 581a has been described, but embodiments of the present disclosure are not limited thereto. In other embodiments, the plurality of electrode pieces 581a may be connected by a method different from the bridge line 582a.

In addition, in the touch panel 50C, it has been described as the example in which the number of the electrode pieces 571a per unit area decreases as the distance from the center line M1 of the first touch electrode 57 increases, and the number of the electrode pieces 581a per unit area decreases as the distance from the center line M2 of the second touch electrode 58 increases.

However, embodiments of the present disclosure are not limited thereto. In other embodiments, for example, the number may be the same regardless of the distance from the center lines M1 and M2.

The touch panel and the display device according to the present disclosure can increase the number of touch electrodes included in the touch area, and as a result, the can be accurately detected.

In addition, the contents of the configuration and control of each part described in each embodiment are not limited to those described above, and may be changed according to the purpose or use. In addition, the configuration and control that combine each embodiment are all included in the present disclosure. In other words, the present disclosure is not limited to each of the above embodiments, and may be modified based on the technical idea of the present disclosure. For example, the present disclosure includes a configuration in which each of the above-described embodiments is organically combined.

What is claimed is:

1. A touch panel comprising:
a plurality of touch electrodes arranged in a matrix shape in a first direction and a second direction that intersects the first direction,
wherein a touch electrode from the plurality of touch electrodes has a length 1.5 times or longer than a distance between the touch electrode and another touch electrode from the plurality of touch electrodes that is adjacent to the touch electrode in the first direction or the second direction, and
wherein the length of the touch electrode is in a direction intersecting the first direction and the second direction.

2. The touch panel according to claim 1, wherein the touch electrode includes a pattern having a gap in a plan view of the touch panel, and a part of a pattern of another adjacent touch electrode from the plurality of touch electrodes is in the gap.

3. The touch panel according to claim 2, wherein each of four regions obtained by equally dividing the touch electrode along the first direction and the second direction includes four patterns of four adjacent touch electrodes from the plurality of touch electrodes.

4. The touch panel according to claim 2, wherein the pattern of the touch electrode is a spiral pattern extending spirally from a predetermined center of the touch electrode in a plan view.

5. The touch panel according to claim 4, wherein a plurality of spiral patterns of adjacent touch electrodes from the plurality of touch electrodes share a center.

6. The touch panel according to claim 5, wherein a circumferential portion of another touch electrode from the plurality of touch electrodes is in a gap between two adjacent circumferential portions included in the spiral pattern.

7. The touch panel according to claim 6, wherein the touch electrode includes:
four spiral patterns arranged in a matrix shape in the first direction and the second direction; and
a connecting pattern in a center portion of the touch electrode, the connecting pattern connecting the four spiral patterns.

8. The touch panel according to claim 7, wherein a line width of each of the four spiral patterns and the connecting pattern narrows as a distance from the center portion increases.

9. The touch panel according to claim 2, wherein the pattern is a mosaic pattern including a plurality of electrode pieces having a predetermined shape.

10. The touch panel according to claim 9, wherein a plurality of electrode pieces of another adjacent touch electrodes from the plurality of touch electrodes are in gaps of the mosaic pattern.

11. The touch panel according to claim 9, wherein a plurality of adjacent electrode pieces of the mosaic pattern are connected to each other via a line that is in a layer that is different from a layer of the plurality of adjacent electrode pieces.

12. The touch panel according to claim 9, wherein a number of the plurality of electrode pieces per unit area decreases as a distance from a center portion of the touch electrode increases.

13. The touch panel according to claim 2, wherein an area including at least three touch electrodes from the plurality of touch electrodes inside a circle with a diameter of 5 mm occupies ½ or more of the touch panel in its entirety.

14. The touch panel according to claim 2, wherein further comprising:
a detection circuit configured to detect a change in capacitance of each of the plurality of touch electrodes.

15. A touch panel comprising:
a plurality of first touch electrodes, each of the plurality of first touch electrodes extending in a first direction; and
a plurality of second touch electrodes, each of the plurality of second touch electrodes extending in a second direction that intersects the first direction,
wherein a width of a first touch electrode from the plurality of first touch electrodes in the second direction is longer than a distance between another adjacent first touch electrodes from the plurality of first touch electrodes, and
wherein a width of a second touch electrode from the plurality of second touch electrodes in the first direction is longer than a distance between another adjacent second touch electrodes from the plurality of second touch electrodes.

16. The touch panel according to claim 15, wherein each of the first touch electrode and the second touch electrode includes a pattern having a gap in a plan view of the touch panel,
wherein a part of the pattern of another first touch electrode from the plurality of first touch electrodes that is adjacent to the first touch electrode and a part of the pattern of the second touch electrode intersecting the first touch electrode are in the gap of the first touch electrode, and
wherein a part of the pattern of another second touch electrode from the plurality of second touch electrodes that is adjacent to the second touch electrode and a part of the pattern of the first touch electrode intersecting the second touch electrode are in the gap of the second touch electrode.

17. The touch panel according to claim 16, wherein the pattern is a spiral pattern extending spirally from a predetermined center in the plan view.

18. The touch panel according to claim 17, wherein a plurality of spiral patterns of the first touch electrode and the second touch electrode that are adjacent to each other share a center.

19. The touch panel according to claim 18, wherein a circumferential portion of each of another first touch electrode and another second touch electrode is in a gap between two adjacent circumferential portions included in the spiral pattern.

20. The touch panel according to claim 19, wherein each of the first touch electrode and the second touch electrode includes:
a plurality of spiral patterns arranged in two rows; and
a connecting pattern on a center line between two rows and connecting the plurality of spiral patterns of the two rows.

21. The touch panel according to claim 20, wherein a line width of the spiral pattern is narrows as a distance from the center line increases.

22. The touch panel according to claim 16, wherein the pattern is a mosaic pattern including a plurality of electrode pieces having a predetermined shape.

23. The touch panel according to claim 22, wherein the plurality of electrode pieces of another adjacent first touch electrode and another adjacent second touch electrode are in the gap of the mosaic pattern.

24. The touch panel according to claim 22, wherein a plurality of adjacent electrode pieces of the mosaic pattern are connected to each other via a line in a layer that is different from a layer of the plurality of adjacent electrode pieces.

25. The touch panel according to claim 22, wherein a number of electrode pieces per unit area decreases as a distance from a center line of the first touch electrode or the second touch electrode increases.

26. The touch panel according to claim 16, wherein an area including at least three of the plurality of first touch electrodes or the plurality of second touch electrodes inside a circle with a diameter of 5 mm occupies ½ or more of the touch panel in its entirety.

27. The touch panel according to claim 16, wherein further comprising:
a detection circuit configured to detect a change in capacitance between the first touch electrode and the second touch electrode.

28. A display device comprising:
the touch panel according to claim 1; and
a display panel on a rear surface side of the touch panel.
